(19) United States
(12) Patent Application Publication
(10) Pub. No.: US 2004/0147655 A1
(43) Pub. Date: Jul. 29, 2004

(54) Aromatic polycarbonate resin composition

(76) Inventors: Toru Sawaki, Yamaguchi (JP); Masasi Simonaru, Yamaguchi (JP); Masahiro Murakami, Yamaguchi (JP); Katsushi Sasaki, Yamaguchi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/432,821

(22) PCT Filed: Mar. 27, 2002
(86) PCT No.: PCT/JP02/02999

(30) Foreign Application Priority Data
Sep. 27, 2001 (JP) 2001-296325

(51) Int. Cl. C08K 3/26; C08K 3/34; C08K 3/04

(52) U.S. Cl. 524/425; 524/492; 524/445; 524/495

(57) ABSTRACT

To provide a high-quality polycarbonate composition comprising a polycarbonate which is free from a reduction in molecular weight by filtration, discoloration or the formation of foreign matter and obtained by using a polymer filter having a small opening size to have a low content of foreign matter. This composition comprises (A) a polycarbonate having a viscosity average molecular weight of 10,000 or more obtained by filtration in a molten state with a filter comprising an assembly of a plurality of disk filter elements having an outer diameter of 15 inches (38.1 cm) or less, an inner diameter/outer diameter ratio of 1/7 or more and an opening size of 40 μm or less, an inorganic filler (B1) and/or a thermoplastic resin (B2) other than polycarbonates.

### FIELD OF THE INVENTION

The present invention relates to an aromatic polycarbonate resin composition. More specifically, it relates to a polycarbonate resin composition which is excellent in transparency and color and has a low content of foreign matter.

### PRIOR ART

Aromatic polycarbonate resins are used in a wide variety of fields because they are excellent in mechanical properties such as impact resistance as well as in heat resistance and transparency. Known processes for producing the above polycarbonate resins include one in which an aromatic dihydroxy compound such as bisphenol A and phosgene as a carbonate bond forming precursor are directly reacted with each other (interfacial polymerization process) and one in which an ester exchange reaction is carried out between an aromatic dihydroxy compound and a carbonic acid diester as a carbonate bond forming precursor in a molten state (melting process).

The process for producing a polycarbonate resin through an ester exchange reaction between an aromatic dihydroxy compound and a carbonic acid diester (melting process) is considered as promising in the future because it is free from problems caused by use of harmful phosgene and a halogen compound such as methylene chloride as a solvent and capable of producing a polycarbonate resin at a low cost, compared with the interfacial polymerization process.

Polycarbonate resins are generally used for optical and electrical applications according to their characteristic properties and an extremely low content of foreign matter is desired in these applications. Foreign matter contained in the polycarbonate resins can be divided into foreign matter contained in raw materials and coming from the outside of a reaction system and foreign matter formed in a reactor and a flow path of a highly viscous material after a reaction. For the former, a filter for removing foreign matter contained in raw materials is used or the air tightness of the reaction system is improved to prevent entry of foreign matter. For the latter, a polycarbonate resin obtained by polymerization is filtered with a filter (to be referred to as “polymer filter” hereinafter) to remove foreign matter.

Since a polycarbonate resin obtained by the melting process which is expected from an environmental point of view and an economical point of view is polymerized at a high temperature for a long time and an ester exchange catalyst such as an alkali metal compound is used, foreign matter is readily formed in the reactor and the flow path of a highly viscous material after the reaction. The removal of foreign matter with the polymer filter plays an important role.

It is often considered as natural that a polycarbonate having a low content of foreign matter is obtained by using filter elements having a small opening size for the filtration of a polycarbonate. As a matter of fact, when the opening size is reduced, the quality of the obtained polymer lowers. This is a phenomenon which is closely connected with the feature of the polycarbonate that a gel is easily formed by the retention of the polymer and occurs due to the expansion of the polymer retention portion of the filter element caused by a reduction in the opening size. Therefore, a special technology must be developed to improve filtration accuracy when filter elements having a small opening size are used.

In contrast to this, as for the filtration of a polymer used for optical applications, JP-A 63-91231 (the term “JP-A” as used herein means an “unexamined published Japanese patent application”) teaches that a sintered metal filter having a filtration accuracy of 1 to 10 μm is used to filter a polymer as means of removing foreign matter contained in a composition comprising polyphenylene ether and an aromatic vinyl polymer and that a disk filter may be used. However, the above publication fails to disclose means of preventing the deterioration of the polymer in the filter though the polymer is not a polycarbonate. JP-A 5-239334 discloses a method of filtering a polycarbonate produced by the melting process with a polymer filter while it is molten after additives are added to and kneaded with the polycarbonate. This method does not require re-melting, reduces the formation of foreign matter due to the reduction of heat history and suppresses the deterioration of the polymer by re-melting as it contains additives. However, the method is a technology for preventing the deterioration during re-melting of a polymer, but is not a technology for preventing the deterioration of the polymer in the polymer filter.

Therefore, a technology for obtaining a polycarbonate having a low content of foreign matter by using a polymer filter having a small opening size has not been developed yet to solve problems with the polycarbonate such as a reduction in the molecular weight of the polymer when it is filtered with the polymer filter, discoloration of the polymer and the formation of foreign matter. A molded article of a polycarbonate having a low content of foreign matter and excellent quality, and a composition comprising the polycarbonate are desired.

### SUMMARY OF THE INVENTION

It is an object of the present invention to provide a polycarbonate resin composition which prevents the deterioration of a polycarbonate in a polymer filter and suppresses discoloration and the formation of black foreign matter and a gel.

Other objects and advantages of the present invention will become apparent from the following description.

According to the present invention, the above objects and advantages of the present invention are attained by a resin composition comprising (A) an aromatic polycarbonate having a viscosity average molecular weight of at least 10,000 obtained by filtration in a molten state with a filter comprising an assembly of a plurality of disk filter elements having an outer diameter of 15 inches or less, an inner diameter/outer diameter ratio of 1/7 or more and an opening size of 40 μm or less, and (B) at least one selected from the group consisting of (B1) an inorganic filler and (B2) a thermoplastic resin other than polycarbonates.

### BRIEF DESCRIPTION OF THE DRAWINGS

FIG. 1 is a schematic sectional view of an example of a filter unit used in the present invention;

FIG. 2 is a schematic plane view of an example of a disk filter element used in the present invention;

FIG. 3 is a schematic sectional view of the disk filter element of FIG. 2;

FIG. 4 is a schematic perspective view of an example of a radial spacer interposed between disk filter elements;

FIG. 5 is a schematic perspective view of an example of a concentric spacer interposed between disk filter elements; and

FIG. 6 is a schematic diagram of a filter unit for explaining the largest area A of a flow path in the filter unit.

### DETAILED DESCRIPTION OF THE PREFERRED EMBODIMENT

Preferably, the aromatic polycarbonate (A) of the present invention consists essentially of a recurring unit represented by the following formula (1):

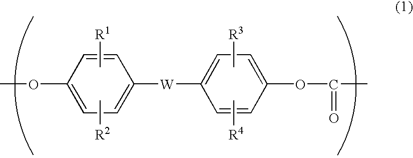

wherein R¹, R², R³ and R⁴ are each independently a hydrogen atom, alkyl group having 1 to 10 carbon atoms, aryl group having 6 to 10 carbon atoms or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group or sulfone group.

The alkyl group having 1 to 10 carbon atoms may be linear or branched. Examples of the alkyl group having 1 to 10 carbon atoms include methyl, ethyl, propyl, butyl, octyl and decyl. Examples of the aryl group having 6 to 10 carbon atoms include phenyl, tolyl, cumyl and naphthyl. Examples of the aralkyl group having 7 to 10 carbon atoms include benzyl, 2-phenethyl and 2-methyl-2-phenylethyl.

Preferably, R¹, R², R³ and R⁴ are each independently a hydrogen atom, methyl group or t-butyl group, particularly preferably a hydrogen atom.

W is as defined hereinabove.

The alkylene group having 1 to 10 carbon atoms may be linear or branched. Examples of the alkylene group having 1 to 10 carbon atoms include methylene, 1,2-ethylene, 1,3-propylene, 1,4-butylene and 1,10-decylene.

Examples of the alkylidene group having 2 to 10 carbon atoms include ethylidene, 2,2-propylidene, 2,2-butylidene and 3,3-hexylidene.

Examples of the cycloalkylene group having 6 to 10 carbon atoms include 1,4-cyclohexylene and 2-isopropyl-1,4-cyclohexylene.

Examples of the cycloalkylidene group having 6 to 10 carbon atoms include cyclohexylidene and isopropylcyclohexylidene.

Examples of the alkylene-arylene-alkylene group having 8 to 15 carbon atoms include m-diisopropylphenylene.

W is preferably a cyclohexylidene group or 2,2-propylidene group, particularly preferably a 2,2-propylidene group.

The aromatic polycarbonate contains the recurring unit represented by the above formula (1) in an amount of 50 mol % or more, preferably 70 mol % or more, particularly preferably 80 mol % or more based on the total of all the recurring units. People of ordinary skill in the art will understand from the following description a recurring unit other than the recurring unit represented by the above formula (1), which may be contained according to circumstances.

It is desired that the aromatic polycarbonate used in the present invention should have preferably an aryloxy group and a phenolic hydroxyl group as main terminal groups and contain the phenolic terminal group in an amount of preferably 50 mol % or less, more preferably 40 mol % or less, much more preferably 30 mol % or less. When the aromatic polycarbonate contains the phenolic terminal group in the above ratio, the object of the present invention can be attained more advantageously and also the moldability, for example, mold contamination resistance and releasability of the composition improve.

When the amount of the phenolic terminal group is reduced to 5 mol % or less, further improvement of the physical properties of the resin is rare. When the amount of the phenolic terminal group is increased to 50 mol % or more, it is not preferred from the viewpoint of attaining the object of the present invention.

As the aryloxy group is preferably used a phenyloxy group substituted by a hydrocarbon group having 1 to 20 carbon atoms, or a nonsubstituted phenyloxy group. The substituent is preferably a tertiary alkyl group, tertiary aralkyl group or aryl group from the viewpoint of resin heat stability.

Preferred examples of the aryloxy group include phenoxy group, 4-t-butylphenyloxy group, 4-t-amylphenyloxy group, 4-phenylphenyloxy group and 4-cumylphenyloxy group.

The aromatic polycarbonate (A) is preferably obtained by melt polycondensing the corresponding aromatic dihydroxy compound and carbonic acid diester as starting materials.

The aromatic polycarbonate (A) has a viscosity average molecular weight of at least 10,000, preferably 10,000 to 100,000, more preferably 10,000 to 50,000. The ratio (Mw/Mn) of the weight average molecular weight (Mw) to the number average molecular weight (Mn) of the aromatic polycarbonate is preferably 3.6 to 1.8, more preferably 3 to 2, from the viewpoints of resin flowability and transferability.

The aromatic polycarbonate (A) of the present invention may contain 1) a sulfonic acid compound, 2) a phosphorus compound, 3) an ester of an aliphatic alcohol and aliphatic carboxylic acid and other additives.

The sulfonic acid compound used in the present invention is preferably represented by the following formula (2):

A₂—SO₃X¹ (2)

wherein A₂ is a hydrocarbon group having 1 to 20 carbon atoms which may have a substituent and X¹ is an ammonium cation or phosphonium cation.

By adding this, the activity of an alkali metal or alkaline earth metal compound used as a polycondensation catalyst can be reduced or deactivated when a polycarbonate is produced by the melting process, thereby making it possible to obtain a polycarbonate having excellent quality such as color, heat resistance and hydrolytic resistance. Therefore, when a polycarbonate obtained by melt polymerization is used, the addition of a sulfonic acid compound is particularly effective.

The sulfonic acid compound is particularly preferably a sulfonic acid phosphonium salt represented by the following formula (3) because its effect is large:

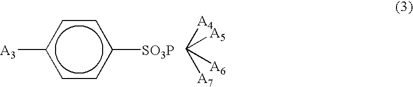

wherein A₃, A₄, A₅, A₆ and A₇ are each independently a monovalent hydrocarbon group having 1 to 20 carbon atoms.

The sulfonic acid compound functions as a deactivator for an ester exchange polycondensation catalyst used for the production of a polycarbonate and improves the heat stability of the polymer.

Known catalyst deactivators as disclosed by JP-A 8-59975 are effectively used as the sulfonic acid compound. Out of these, ammonium salts of sulfonic acid and phosphonium salts of sulfonic acid are preferred. Further, ammonium salts and phosphonium salts of dodecylbenzenesulfonic acid, ammonium salts and phosphonium salts of paratoluenesulfonic acid, and ammonium salts and phosphonium salts of benzenesulfonic acid are also preferably used.

Out of these, tetrabutylphosphonium dodecylbenzenesulfonate and tetrabutylammonium paratoluenesulfonate are particularly preferred in the present invention because their effects are excellent.

The sulfonic acid compound as a catalyst deactivator, may be added to the polycarbonate alone or in mixture with water as an aqueous solution.

The amount of the catalyst deactivator which is the sulfonic acid compound to be added to the polycarbonate obtained by melt polycondensation is preferably 0.5 to 50 mols, more preferably 0.5 to 10 mols, particularly preferably 0.8 to 5 mols based on 1 mol of the main polycondensation catalyst selected from an alkali metal compound and an alkali earth metal compound. This is equivalent to 0.1 to 500 ppm based on the polycarbonate.

The phosphorus compound used in the present invention is phosphoric acid, phosphorous acid, hypophosphorous acid, pyrophosphoric acid, polyphosphoric acid, phosphoric acid ester or phosphorous acid ester.

Examples of the phosphoric acid ester include trialkyl phosphates such as trimethyl phosphate, triethyl phosphate, tributyl phosphate, trioctyl phosphate, tridecyl phosphate, trioctadecyl phosphate and distearyl pentaerythrityl diphosphate; tricycloalkyl phosphates such as tricyclohexyl phosphate; and triaryl phosphates such as triphenyl phosphate, tricresyl phosphate, tris(nonylphenyl)phosphate and 2-ethylphenyldiphenyl phosphate.

The phosphorous acid ester is a compound represented by the following formula (4):

P(OR)₃ (4)

wherein R is an aliphatic hydrocarbon group, alicyclic hydrocarbon group or aromatic hydrocarbon group, with the proviso that three R's may be the same or different.

Examples of the compound represented by the above formula (4) include trialkyl phosphites such as trimethyl phosphite, triethyl phosphate, tributyl phosphate, trioctyl phosphate, tris(2-ethylhexyl)phosphite, trinonyl phosphite, tridecyl phosphite, trioctadecyl phosphate and tristearyl phosphate; tricycloalkyl phosphates such as tricyclohexyl phosphate; triaryl phosphites such as triphenyl phosphite, tricresyl phosphite, tris(ethylphenyl)phosphite, tris(2,4-di-t-butylphenyl)phosphite, tris(nonylphenyl)phosphite; and tris (hydroxyphenyl)phosphite, and arylalkyl phosphites such as phenyldidecyl phosphate, diphenyldecyl phosphite, diphenylisooctyl phosphite, phenylisooctyl phosphate and 2-ethylhexyldiphenyl phosphite. Further, distearyl pentaerythrityl diphosphite and bis(2,4-di-t-butylphenyl)pentaerythrityl diphosphite may also be used as the phosphorous acid ester.

These compounds may be used alone or in combination. Out of these, phosphorous acid esters represented by the above formula (4) are more preferred, and aromatic phosphorous acid esters are particularly preferred as the phosphorus compound.

The phosphorus compound in the present invention may be added in an amount of preferably 0.0001 to 0.1 part by weight, more preferably 0.001 to 0.05 part by weight based on 100 parts by weight of the polycarbonate. Outside the above range, a satisfactory effect may not be obtained by adding the phosphorus compound or a bad influence may be exerted upon the quality of the polymer disadvantageously.

In the present invention, a specific phosphonium salt may be used as the phosphorus compound. The specific phosphonium salt is a phosphoric acid phosphonium salt, phosphonic acid phosphonium salt, condensation phosphoric acid phosphonium salt, phosphorous acid phosphonium salt, phosphonous acid phosphonium salt and boric acid phosphonium salt. They may be used alone or in combination of two or more.

The amount of the specific phosphonium salt used in the present invention is preferably 0.01×10⁻⁴ to 30×10⁻⁴ part by weight, more preferably 0.005×10⁻⁴ to 20×10⁻⁴ part by weight, much more preferably 0.01×10⁻³ to 10×10⁻⁴ part by weight, particularly preferably 0.05×10⁻³ to 8×10⁻⁴ part by weight in terms of the total of phosphorus atoms based on 100 parts by weight of the aromatic polycarbonate.

The above phosphoric acid phosphonium salt, condensation phosphoric acid phosphonium salt and phosphonic acid phosphonium salt are a compound represented by the following formula (5)-1:

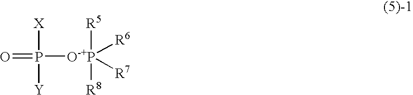

The phosphorous acid phosphonium salt and phosphonous acid phosphonium salt are a compound represented by the following formula (5)-2:

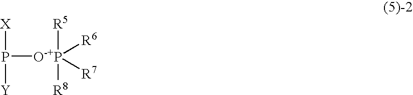

Further, the boric acid phosphonium salt is a compound represented by the following formula (5)-3:

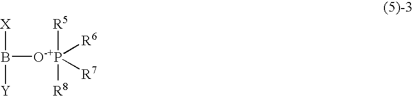

In the above formulas (5)-1, (5)-2 and (5)-3, R⁵ to R⁸ are each independently a hydrocarbon group having 1 to 10 carbon atoms, and X and Y are each independently a hydroxy group, quaternary phosphonium salt represented by the following formula (6), alkoxy group having 1 to 20 carbon atoms, cycloalkoxy group having 4 to 20 carbon atoms, aryloxy group having 6 to 20 carbon atoms, aralkyloxy group having 7 to 20 carbon atoms, alkyl group having 1 to 20 carbon atoms, cycloalkyl group having 4 to 20 carbon atoms, aryl group having 6 to 20 carbon atoms or aralkyl group having 7 to 20 carbon atoms.

That is, the quaternary phosphonium group represented by X and Y is at least one selected from phosphonium salt compounds having a specific structure represented by the following formula (6):

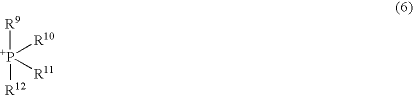

wherein R⁹ to R¹² are defined the same as R⁵ to R⁸.

Specific examples of the phosphonium salt represented by the above formula (5)-1 include phosphoric acid triphosphonium salts, phosphoric acid monohydrogen diphosphonium salts, phosphoric acid dihydrogen phosphonium salts, phosphonic acid diphosphonium salts and phosphonic acid monohydrogen phosphonium salts. Specific examples of the phosphonium salt represented by the above formula (5)-2 include phosphorous acid triphosphonium salts, phosphorous acid monohydrogen diphosphonium salts, phosphorous acid dihydrogen phosphonium salts, phosphonous acid diphosphonium salts and phosphonous acid monohydrogen phosphonium salts. Specific examples of the boric acid phosphonium salt represented by the above formula (5)-3 include boric acid triphosphonium salts, boric acid monohydrogen diphosphonium salts, boric acid dihydrogen phosphonium salts and one organic group-substituted hydroxyboran phosphonium salts.

Out of these specific phosphonium salts, particularly preferred are tris(tetramethylphosphonium)phosphate, tris(tetrabutylphosphonium)phosphate, bis(tetramethylphosphonium)monohydrogenphosphate, bis(tetrabutylphosphonium)monohydrogenphosphate, tetramethylphosphonium dihydrogenphosphate, tetrabutylphosphonium dihydrogenphosphate, bis(tetramethylphosphonium)benzenephosphonate, (tetrabutylphosphonium)phenylmonohydrogenphosphonate, tris(tetramethylphosphonium)phosphite, tris(tetrabutylphosphonium)phosphite, bis(tetramethylphosphonium)monohydrogenphosphite, bis(tetrabutylphosphonium)monohydrogenphosphite, tetramethylphosphonium dihydrogenphosphite, tetrabutylphosphonium dihydrogenphosphite, bis(tetramethylphosphonium)phenylphosphonite, bis(tetrabutylphosphonium)phenylphosphonite, tris(tetramethylphosphonium)borate, tris(tetrabutylphosphonium)borate, bis(tetramethylphosphonium)monohydrogenborate, bis(tetrabutylphosphonium)monohydrogenborate, tetramethylphosphonium dihydrogenborate and tetrabutylphosphonium dihydrogenborate.

Out of the above phosphonium salts, preferred are acidic phosphonium salts, that is, acidic phosphoric acid phosphonium salts, acidic phosphonic acid phosphonium salts, condensation acidic phosphoric acid phosphonium salts, acidic phosphorous acid phosphonium salts, acidic phosphonous acid phosphonium salts and acidic boric acid phosphonium salts.

In the present invention, an acidic phosphonium salt such as a sulfuric acid acidic phosphonium salt or a sulfurous acid acidic phosphonium salt may be further optionally used in combination with these specific phosphonium salts.

Out of the specific phosphonium salts, a phosphoric acid acidic phosphonium salt or mono- or di-alkali metal salt of an ester thereof, neutral phosphoric acid phosphonium salt, neutral sulfonic acid phosphonium salt, neutral sulfuric acid phosphonium salt or neutral sulfurous acid phosphonium salt may be optionally used in limits not prejudicial to the object of the present invention. The effect of improving the flame retardancy of the composition additionally is seen when the phosphonium salt is added.

As for the amount of the mono- or di-alkali metal salt, the total amount of phosphorus atoms contained in the compound is 0.001 to 50 wt % based on the total of phosphorus atoms contained in the specific phosphoric acid acidic phosphonium salt used. It is preferably 0.01 to 30 wt %, more preferably 0.05 to 10 wt % based on the same standard. The effect of improving the flame retardancy of the composition additionally is seen when the phosphonium salt is added.

The ester of an aliphatic alcohol and an aliphatic carboxylic acid used in the present invention serves to improve the releasability of the composition. The ester of an aliphatic alcohol and an aliphatic carboxylic acid is preferably an ester of a polyhydric alcohol and a saturated or unsaturated higher fatty acid having 10 to 22 carbon atoms. The ester has an HLB value of preferably 3 to 7, more preferably 3 to 6. When a partial ester having an HLB value of 3 to 6 is used in conjunction with a specific phosphonium salt, the effects of improving releasability and suppressing the contamination of a metal mold are large.

The term “HLB” stands for and means hydrophile-lipophile balance as described at page 24 of “Surfactant” written by Fumio Kitahara and three others and published by Kodansha Co., Ltd.

The partial ester which satisfies the above balance is a partial ester of a saturated or unsaturated aliphatic mono-, di- or tri-carboxylic acid and a saturated or unsaturated polyhydric alcohol. Examples of this polyhydric alcohol include saturated and unsaturated divalent alcohols such as ethylene glycol, propylene glycol, 1,4-butenediol and diethylene glycol, saturated and unsaturated trivalent alcohols such as glycerin and trimethylolpropane, saturated and unsaturated tetravalent alcohols such as pentaerythritol, and saturated and unsaturated polyhydric alcohols having 5 or more hydroxyl groups.

Examples of the higher fatty acid include linear carboxylic acids such as lauric acid, myristic acid, palmitic acid, stearic acid and behenic acid, branched carboxylic acids such as isodecanoic acid, isotridecanoic acid, isomyristic acid, isopalmitic acid, isostearic acid and isoarachic acid, and other unsaturated carboxylic acids such as oleic acid, linoleic acid linolenic acid, 5,8,11,14-eicosatetraenoic acid and 4,7,10,13,16,19-docosahexaenoic acid.

Examples of the polyhydric alcohol include propylene glycol, glycerin, 2,2-dihydroxyperfluoropropanol, neopentylene glycol, pentaerythritol and ditrimethylolpropane.

Examples of the partial ester of the polyhydric alcohol and the higher fatty acid include ethylene glycol monostearate, ethylene glycol monooleate, propylene glycol monooleate, propylene glycol monobehenate, propylene glycol monostearate, glycerol monostearate, glycerol monoisostearate, glycerol monolaurate, glycerol monooleate, glycerol monopalmitate, glycerol monoacetostearate, glycerol monobutylether, trimethylolpropane distearate and neopentylene glycol monostearate.

The amount of the ester is preferably 1×10⁻³ to 3×10⁻¹ part by weight, more preferably 5×10⁻³ to 2×10⁻¹ part by weight, particularly preferably ×10⁻³ to 1×10⁻¹ part by weight based on 100 parts by weight of the aromatic polycarbonate. When the amount of the ester is outside the above range, inconvenience for the object of the present invention may occur disadvantageously.

Other release agent whose examples are given below may be optionally used:

1) hydrocarbon-based release agents such as natural and synthetic paraffin waxes, polyethylene wax and fluorocarbons,

2) fatty acid-based release agents such as trimethylolpropanes of a higher fatty acid or oxyfatty acid such as stearic acid or hydroxystearic acid, 3) fatty acid amide-based release agents such as fatty acid amides including ethylene bisstearylamide and alkylenebis fatty acid amides including erucid amide, 4) alcohol-based release agents such as aliphatic alcohols including stearyl alcohol and cetyl alcohol, polyhydric alcohols, polyglycols and polyglycerols, and 5) polysiloxanes.

The amount of the other release agent is preferably 0.0001 to 0.1 part by weight based on 100 parts by weight of the polycarbonate. The above release agents may be used alone or in combination of two or more.

Other additives which can be used in the present invention are not particularly limited but include a processing stabilizer, antioxidant, optical stabilizer, ultraviolet light absorber, metal inactivating agent, metal soap, nucleating agent, antistatic agent, flame retardant, mildew-proofing agent, colorant, anti-fogging agent, natural oil, synthetic oil and wax.

Examples of the processing stabilizer include 2-t-butyl-6-(3-t-butyl-2-hydroxy-5-methylbenzyl)-4-methylphenyl acrylate and 2-[1-(2-hydroxy-3,5-di-t-pentylphenyl)ethyl]-4,6-di-t-pentylphenyl acrylate.

Examples of the optical stabilizer include ultraviolet light absorbers such as benzotriazole-based compounds including 2-(3-t-butyl-2-hydroxy-5-methylphenyl)-5-chlorobenzotriazole, 2-(3,5-di-t-butyl-2-hydroxyphenyl)benzotriazole, 2-(2-hydroxy-5-methylphenyl)benzotriazole, 2-(2-hydroxy-5-t-octylphenyl)benzotriazole, 2-(3,5-di-t-pentyl-2-hydroxyphenyl)benzotriazole, 2-[2-hydroxy-3-(3,4,5,6-tetrahydrophthalimidemethyl) phenyl]benzotriazole and 2-[2-hydroxy-3,5-bis(α,α-dimethylbenzyl)phenyl]benzotriazole; benzophenone-based compounds including 2-hydroxy-4-octyloxybenzophenone and 2-hydroxy-4-methoxybenzophenone; hydroxybenzophenone-based compounds including 2,4-di-t-butylphenyl and 3,5-di-t-butyl-4-hydroxybenzoate; and cyanoacrylate-based compounds including ethyl-2-cyano-3,3-diphenyl acrylate, and nickel-based quenchers such as nickel dibutyldithiocarbamate and [2,2′-thiobis(4-t-octylphenolate)]-2-ethylhexylamine nickel.

Examples of the metal inactivating agent include N,N′-[3-(3,5-di-t-butyl-4-hydroxyphenyl)propionyl] hydrazine, and examples of the metal soap include calcium stearate and nickel stearate.

Examples of the nucleating agent include sorbitol-based and phosphate-based compounds such as sodium di(4-t-butylphenyl)phosphonate, dibenzylidene sorbitol and methylenebis(2,4-di-t-butylphenol)acid phosphate sodium salt.

Examples of the antistatic agent include quaternary ammonium salt- and alkylphosphate-based compounds such as (β-lauramidepropyl)trimethylammonium methyl sulfate.

Examples of the flame retardant include halogen-containing phosphates such as tris(2-chloroethyl)phosphate, halides such as hexabromocyclododecane and decabromophenyl oxide, metal inorganic compounds such as antimony trioxide, antimony pentaoxide and aluminum hydroxide, and mixtures thereof.

The method of adding the above sulfonic acid compound 1), phosphorus compound 2), ester of an aliphatic alcohol and an aliphatic carboxylic acid 3) and other additives to the aromatic polycarbonate (A) is not particularly limited and the order of blending these components is arbitrary. That is, the sulfonic acid compound 1), phosphorus compound 2), ester of an aliphatic alcohol and an aliphatic carboxylic acid 3) and other additives may be added to and kneaded with the aromatic polycarbonate in a molten state and filtered with a polymer filter in accordance with the method of the present invention, or the aromatic polycarbonate may be filtered in accordance with the method of the present invention and added to and kneaded with the above additives, or some of the additives such as the sulfonic acid compound 1) and the like may be added to and kneaded with the aromatic polycarbonate, filtered with a polymer filter in accordance with the method of the present invention and then added to and kneaded with the rest of the additives. Alternatively, after the polycarbonate filtered with a polymer filter is pelletized, the additives may be added to the polycarbonate, or the additives may be added to and kneaded with the polycarbonate filtered with a polymer filter while it is molten.

In order to reduce the heat history time in a molten state and the number of times of re-melting, it is preferred that the sulfonic acid compound, phosphorus compound, ester of an aliphatic alcohol and an aliphatic carboxylic acid and other additives should be added to and kneaded with the molten polycarbonate obtained by melt polycondensation and then the obtained mixture should be supplied to the polymer filter of the present invention to be filtered.

The apparatus for adding and kneading the additives may be a known apparatus such as a twin-screw extruder. The sulfonic acid compound 1), phosphorus compound 2), ester of an aliphatic alcohol and an aliphatic carboxylic acid 3) and other additives to be supplied to a kneading device may be molten, dissolved in a suitable solvent as a solution, dispersed as an emulsion, dispersed in a polycarbonate as a master powder material, or a master polymer of the polycarbonate. Further, to prepare a composition comprising a resin other than polycarbonates to be described hereinafter, a master powder material or master polymer comprising the resin as a medium may also be used.

These additives may be supplied by known quantitative supply means according to their forms. For example, they may be supplied by a plunger pump, diaphragm pump or gear pump in the case of a liquid such as a molten liquid or solution. In the case of a solid such as a master powder, a combination of a quantitative feeder and a side feeder may be preferably used.

The aromatic polycarbonate composition of the present invention is preferably a composition which comprises (i) an aromatic polycarbonate having a viscosity average molecular weight of 10,000 or more obtained by filtration in a molten state with a filter comprising an assembly of a plurality of disk filter elements having an outer diameter of 15 inches (38.1 cm) or less, an inner diameter/outer diameter ratio of 1/7 or more and an opening size of 40 μm or less, preferably an aromatic polycarbonate comprising 0.1×10⁻⁴ to 500×10⁻⁴ part by weight of the sulfonic acid compound 1), 1×10⁻⁴ to 1,000×10⁻⁴ part by weight, preferably 10×10⁻⁴ to 500×10⁻⁴ part by weight of the phosphorus compound 2) and 1×10⁻³ to 3×10⁻¹ part by weight, preferably 5×10⁻³ to 2×10⁻¹ part by weight of the ester of an aliphatic alcohol and an aliphatic carboxylic acid 3) based on 100 parts by weight of the aromatic polycarbonate, and (B) an inorganic filler (B1) and/or a thermoplastic resin (B2) other than polycarbonates.

The composition of the present invention is obtained by adding and kneading the inorganic filler (B1) and/or the thermoplastic resin (B2) other than polycarbonates with the aromatic polycarbonate which comprises or does not comprise the above additives such as the sulfonic acid compound 1), the phosphorus compound 2) and the ester of an aliphatic alcohol and an aliphatic carboxylic acid 3).

The composition of the present invention may comprise the above component (B) in an amount of 1 to 300 parts by weight based on 100 parts by weight of the above component (A).

Illustrative examples of the composition of the present invention are given below.

(i) A resin composition comprising a polycarbonate (A) and an inorganic filler (B1)

(ii) A resin composition comprising a polycarbonate (A) and a thermoplastic resin (B2) other than polycarbonates

(iii) A resin composition comprising a polycarbonate (A), an inorganic filler (B1) and a thermoplastic resin (B2) other than polycarbonates

The thus obtained polycarbonate composition has excellent color and moldability, reflecting the fact that the polycarbonate used has better color and a lower content of foreign matter than a conventional polycarbonate and provides moldings having excellent mechanical strength.

Examples of the filler (B1) include lamellar and granular inorganic fillers such as talc, mica, glass flake, glass bead, calcium carbonate and titanium oxide, fibrous fillers such as glass fiber, glass milled fiber, wollastonite, carbon fiber, aramide fiber and metal-based conductive fiber, and organic particles such as crosslinked acryl particle and crosslinked silicone particle. The amount of the inorganic filler or organic filler is preferably 1 to 150 parts by weight, more preferably 3 to 100 parts by weight based on 100 parts by weight of the aromatic polycarbonate in the above resin composition (i).

The above inorganic filler may be surface treated with a silane coupling agent. A favorable effect such as the suppression of the decomposition of the aromatic polycarbonate is obtained from this surface treatment.

Examples of the thermoplastic resin (B2) other than polycarbonates used in the composition of the present invention include polyamide resin, polyimide resin, polyether imide resin, polyurethane resin, polyphenylene ether resin, polyphenylene sulfide resin, polysulfone resin, polyolefin resin such as polyethylene, polypropylene and polybutadiene, polyester resin such as polyethylene terephthalate and polybutylene terephthalate, non-crystalline polyarylate resin, polystyrene resin, HIPS (high impact strength polystyrene), acrylonitrile/styrene copolymer (AS resin), acrylonitrile/butadiene/styrene copolymer (ABS resin) and polymethacrylate resin. Out of these, ABS resin, polyester resin such as polyethylene terephthalate and polybutylene terephthalate, polypropylene, AS resin, HIPS and polybutadiene are preferred, and ABS resin and polyester resin are particularly preferred.

In the present invention, the thermoplastic resin (B2) other than polycarbonates is contained in an amount of preferably 10 to 150 parts by weight, more preferably 20 to 100 parts by weight based on 100 parts by weight of the aromatic polycarbonate (A) in the above composition (ii).

In the above composition (iii), preferably, the amount of the inorganic filler (B1) is 1 to 150 parts by weight based on 100 parts by weight of the polycarbonate (A) and the amount of the thermoplastic resin (B2) other than polycarbonates is 10 to 150 parts by weight based on 100 parts by weight of the polycarbonate (A). More preferably, the amount of the inorganic filler (B1) is 3 to 100 parts by weight and the amount of the thermoplastic resin (B2) other than polycarbonates is 20 to 100 parts by weight. The amount of the thermoplastic resin (B2) is preferably 20 to 3,000 parts by weight based on 100 parts by weight of the component (B1).

To prepare the composition, both an aromatic polycarbonate which comprises the above additives including the sulfonic acid compound and an aromatic polycarbonate which does not comprise the additives can be preferably used. The above sulfonic acid compound and other additives may be added to the obtained composition as required in accordance with the above-described addition method.

The aromatic polycarbonate used in the composition of the present invention preferably has a viscosity average molecular weight of 10,000 to 100,000. The viscosity average molecular weight is more preferably 10,000 to 50,000.

The aromatic polycarbonate used in the composition of the present invention is preferably a polycarbonate obtained by filtration in a molten state with a filter comprising an assembly of a plurality of disk filter elements having an outer diameter of 15 inches (38.1 cm) or less, an inner diameter/outer diameter ratio of 1/7 or more and an opening size of 40 μm or less and the filtration is preferably carried out by satisfying at least one of the following conditions.

1) The filtration pressure difference should be 20 kg/cm² or more.

2) The throughput (kg/hr) of the polycarbonate per the unit area (m²) of the filter should be 50 kg/m²/hr or more.

3) The retention time (V/W) in the filter should be represented by the following expression.

V/W=0.2 to 10

(V is an effective volume (1) in the filter, and W is the flow rate (l/min) of the filtered polymer)

4) The lowest flow velocity of the polymer in the filter should be represented by the following expression.

W/A′×1,000=1 to 10,000 cm/min

(W is the flow rate of the filtered polymer (1/min) and A′ is the largest area (cm²) of a polymer flow path in the filter)

5) The interval between the opposite filtration surfaces of adjacent disk filter elements should be 5 mm or less.

Since an aromatic polycarbonate obtained by filtration under conditions other than the above conditions or an aromatic polycarbonate not filtered contains a lot of foreign matter and is deteriorated by filtration, it provides a low-quality composition which has poor stability of mechanical properties at a high humidity and when its molded article is used for a long time, particularly great deterioration or reduction of impact resistance, in addition to poor stability during molding.

The aromatic polycarbonate (A) used in the present invention contains preferably no more than 50 gels, more preferably no more than 30 gels per 1 kg. Each gel has a diameter of at least 20 μm.

The aromatic polycarbonate (A) contains an aromatic monohydroxy compound in an amount of no more than 200 ppm and a diaryl carbonate in an amount of no more than 200 ppm.

A description is subsequently given of the process for producing the aromatic polycarbonate composition of the present invention.

The aromatic polycarbonate resin used in the present invention is produced by reacting a dihydroxy compound essentially composed of an aromatic dihydroxy compound represented by the following formula (7) with a carbonate bond forming precursor in accordance with a solution process or melting process.

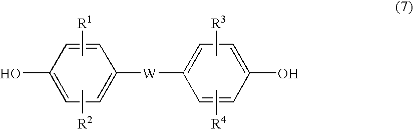

wherein R¹, R², R³, R⁴ and W are as defined in the prescribed formula (1).

Out of these processes, the effect of the present invention can be definitely obtained by the melting process because the aromatic polycarbonate in a molten state can be directly obtained from a polymerizer, the re-melting of the polymer is not necessary and the potential of producing foreign matter such as a gel is higher in the melt polymerization process in which polymerization is carried out at a high temperature than the interfacial polymerization process.

Therefore, the aromatic polycarbonate resin of the present invention is preferably produced by the melting process.

Illustrative examples of the aromatic dihydroxy compound include bis(4-hydroxyaryl)alkanes such as bis(4-hydroxyphenyl)methane, 2,2-bis(4-hydroxyphenyl)propane, 1,1-bis(4-hydroxyphenyl)ethane, 2,2-bis(4-hydroxy-3-methylphenyl)propane, bis(4-hydroxyphenyl)phenylmethane and 4,4′-dihydroxyphenyl-1,1′-m-diisopropylbenzene; bis(hydroxyaryl)cycloalkanes such as 1,1-bis(4-hydroxyphenyl)cyclohexane, 1,1-bis(4-hydroxyphenyl)-3,3,5-trimethylcyclohexane, 2,2,2′,2′-tetrahydro-3,3,3′,3′-tetramethyl-1,1′-spirobis-[1H-indene]-6,6′-diol and 9,9-bis(4-hydroxy-3-methylphenyl)fluorene; dihydroxyaryl ethers such as bis(4-hydroxyphenyl)ether; dihydroxydiaryl sulfides such as 4,4′-dihydroxydiphenyl sulfide and 4,4′-dihydroxy-3,3′-dimethyldiphenyl sulfide; dihydroxydiaryl sulfoxides such as 4,4′-dihydroxydiphenyl sulfoxide; dihydroxydiaryl sulfones such as 4,4′-dihydroxydiphenyl sulfone and 4,4′-dihydroxy-3,3′-dimethyldiphenyl sulfone; dihydroxydiaryl isatins such as 4,4′-dihydroxydiphenyl-3,3′-isatin; dihydroxydiaryl xanthenes such as 3,6-dihydroxy-9,9-dimethylxanthene; dihydroxybenzenes such as resorcin, 5-phenylresorcin, 2-t-butylhydroquinone and 2-phenylhydroquinone; and dihydroxydiphenyls such as 4,4′-dihydroxydiphenyl.

Out of these, 2,2-bis(4-hydroxyphenyl)propane (may be abbreviated as BPA hereinafter) is preferred because it has high stability as a monomer and a low total content of impurities and can be easily acquired.

In the present invention, one or more monomers may be copolymerized in the aromatic polycarbonate as required to control glass transition temperature, improve flowability, increase refractive index or reduce birefringence and control optical properties. The monomers include aliphatic dihydroxy compounds such as 1,4-butanediol, 1,4-cyclohexanedimethanol, 1,10-decanediol, 3,9-bis(1,1-dimethyl-2-hydroxyethyl)-2,4,8,10-tetraoxaspiro[5,5]undecane, diethylene glycol and polytetramethylene glycol; dicarboxylic acids such as terephthalic acid, isophthalic acid, 2,6-naphthalenedicarboxylic acid, adipic acid and cyclohexanedicarboxylic acid; and oxyacids such as p-hydroxybenzoic acid, 6-hydroxy-2-naphthoeic acid and lactic acid.

The carbonate bond forming precursor is a carbonyl halide such as phosgene or haloformate compound in the solution process. In the melting process, it is an aromatic carbonic acid diester such as diphenyl carbonate or ditolyl carbonate. Dimethyl carbonate or dicyclohexyl carbonate may be used as desired. Out of these, diphenyl carbonate (may be abbreviated as DPC hereinafter) is preferred from the viewpoints of reactivity, stability to the discoloration of the obtained resin and cost.

In the solid-phase polymerization process, a polycarbonate resin can be obtained by crystallizing a polycarbonate oligomer having a low molecular weight produced by the above solution process or melting process and polymerizing the crystallized oligomer in a solid state at a high temperature and optionally under reduced pressure. The thus obtained polycarbonate resin can be preferably used as well.

A polyester carbonate containing an ester bond produced by using an ester bond forming precursor together with the carbonate bond forming precursor in the production of a polycarbonate may be used as the aromatic polycarbonate to which the present invention is directed.

The ester bond forming precursor is a dicarboxylic acid or dicarboxylic acid derivative. Examples of these include aromatic dicarboxylic acid derivatives such as terephthalic acid, terephthalic acid chloride, isophthalic acid chloride, diphenyl terephthalate and diphenyl isophthalate; aliphatic dicarboxylic acid derivatives such as succinic acid, adipic acid, dodecanoic diacid, adipic acid chloride, decanoic diacid diphenyl and dodecanoic diacid diphenyl; and alicyclic dicarboxylic acid derivatives such as 1,3-cyclobutanedicarboxylic acid, 1,4-cyclohexanedicarboxylic acid, 1,3-cyclohexanedicarboxylic acid chloride, diphenyl cyclopropane dicarboxylate and diphenyl 1,4-cyclohexane dicarboxylate.

A polyfunctional compound having three or more functional groups in one molecule may be used in conjunction with the aromatic dihydroxy compound for the production of the above aromatic polycarbonate so as to attain a desired object. The polyfunctional compound is preferably a compound having phenolic hydroxyl groups or carboxyl groups. Examples of the polyfunctional compound include 1,1,1-tris(4-hydroxyphenyl)ethane, α,α′,α″-tris(4-hydroxyphenyl)-1,3,5-triisopropylbenzene, 4,6-dimethyl-2,4,6-tris(4-hydroxyphenyl)-heptane-2,1,3,5-tris(4-hydroxyphenyl)benzene, trimellitic acid and pyromellitic acid.

Out of these, 1,1,1-tris(4-hydroxyphenyl)ethane, α,α′,α″-tris(4-hydroxyphenyl)-1,3,5-triisopropylbenzene and trimellitic acid are preferred.

A tertiary amine, quaternary ammonium salt, quaternary phosphonium salt, nitrogen-containing heterocyclic compound or salt thereof, iminoether or salt thereof, or compound having an amide group may be used as a catalyst in the solution process for the production of the aromatic polycarbonate. In the solution process, a large amount of an alkali metal compound or alkali earth metal compound is used as a scavenger for a hydrogen halide such as hydrochloric acid formed by a reaction. Therefore, it is preferred to completely clean or purify the produced polymer to prevent such impurities from remaining therein.

An ester exchange catalyst is preferably used in the melting process and solid-phase polymerization process.

The catalyst may be a conventionally known ester exchange catalyst. An alkali metal compound or an alkali earth metal compound which is such a catalyst is, for example, a hydroxide, hydrocarbon compound, carbonate, carboxylate, nitrate, nitrite, sulfite, cyanate, thiocyanate, borohydride, hydrogenphosphate, aromatic hydroxy compound or the like.

Specific examples of the alkali metal compound include lithium hydroxide, sodium hydroxide, rubidium hydroxide, cesium hydroxide, lithium bicarbonate, potassium bicarbonate, rubidium bicarbonate, cesium bicarbonate, lithium carbonate, sodium carbonate, rubidium carbonate, cesium carbonate, lithium acetate, sodium acetate, potassium acetate, rubidium acetate, lithium stearate, rubidium stearate, cesium stearate, lithium benzoate, sodium benzoate, rubidium benzoate, cesium benzoate, cesium nitrate, rubidium nitrite, potassium sulfite, lithium cyanate, sodium cyanate, rubidium cyanate, cesium cyanate, lithium thiocyanate, potassium thiocyanate, rubidium thiocyanate, cesium thiocyanate, lithium borohydride, sodium borohydride, potassium borohydride, potassium tetraphenylborate, dilithium phosphite, potassium hypophosphite, dilithium hydrogenphosphate, trilithium phosphate, and dilithium salts, monolithium salts, lithium sodium salts, lithium phenoxides, sodium phenoxides, rubidium phenoxides, cesium phenoxides, lithium 2,6-di-t-butyl-4-methylphenoxide, sodium 2,6-di-t-butyl-4-methylphenoxide, rubidium 2,6-di-t-butyl-4-methylphenoxide and cesium 2,6-di-t-butyl-4-methylphenoxide of bisphenol A.

Specific examples of the alkali earth metal compound include calcium hydroxide, strontium hydroxide, barium bicarbonate, barium carbonate, magnesium carbonate, barium acetate, magnesium myristate, strontium benzoate, calcium cyanate, barium cyanate, calcium thiocyanate and barium thiocyanate.

The amount of the catalyst is preferably 1×10⁻⁸ to 5×10⁻⁵ chemical equivalent, more preferably 5×10⁻⁸ to 5×10⁻⁶ chemical equivalent in terms of an alkali metal or alkali earth metal based on 1 mol of the aromatic dihydroxy compound. When the amount is outside the above range, the catalyst may exert a bad influence upon the physical properties of the obtained polycarbonate or an ester exchange reaction may not proceed fully, thereby making it difficult to obtain a polycarbonate having a high molecular weight.

A basic nitrogen-containing compound and/or a basic phosphorus-containing compound are/is preferably used as a co-catalyst.

The amount of the co-catalyst is preferably 1×10⁻⁵ to 5×10⁻³ chemical equivalent, more preferably 5×10⁻⁵ to 5×10⁻⁴ chemical equivalent based on 1 mol of the dihydroxy compound. When the amount is outside the above range, the co-catalyst may exert a bad influence upon the physical properties of the obtained polycarbonate or an ester exchange reaction may not proceed fully, thereby making it difficult to obtain a polycarbonate having a high molecular weight.

Examples of the basic nitrogen-containing compound include quaternary ammonium hydroxides having an alkyl, aryl or alkylaryl group such as tetramethylammonium hydroxide (Me₄NOH), tetrabutylammonium hydroxide (Bu₄NOH) and benzyltrimethylammonium hydroxide (φ-CH₂(Me)₃NOH); basic ammonium salts having an alkyl, aryl or alkylaryl group such as tetramethylammonium acetate, tetraethylammonium phenoxide, tetrabutylammonium carbonates and hexadecyltrimethylammonium ethoxide; tertiary amines such as triethylamine; and basic salts such as tetramethylammonium borohydride (Me₄NBH₄), tetrabutylammonium borohydride (Bu₄NBH₄), and tetramethylammonium tetraphenyl borate (Me₄NBPh₄).

Examples of the basic phosphorus-containing compound include quaternary phosphonium hydroxides having an alkyl, aryl or alkylaryl group such as tetrabutylphosphonium hydroxide (Bu₄POH), benzyltrimethylphosphonium hydroxide (φ-CH₂(Me)₃POH) and hexadecyltrimethylphosphonium hydroxide; and basic salts such as tetrabutylphosphonium borohydride (BU₄PBH₄) and tetrabutylphosphonium tetraphenyl borate (Bu₄PBPh₄).

In the melt polymerization process out of the above polymerization processes, an aromatic polycarbonate having a reduced number of terminal phenolic groups is preferably produced by the following methods:

I) method of controlling the molar ratio of charge stocks; The DPC/BPA molar ratio is increased to a range of 1.01 to 1.10 at the time of charging for a polymerization reaction in consideration of the characteristic features of a polymerization reactor.

2) terminal capping method; At the end of a polymerization reaction, terminal hydroxyl groups are capped with a salicylate-based compound disclosed by U.S. Pat. No. 5,696,222 in accordance with a method disclosed by the document.

The amount of the salicylate-based compound is preferably 0.8 to 10 mols, more preferably 0.8 to 5 mols, particularly preferably 0.9 to 2 mols based on 1 chemical equivalent of the terminal hydroxyl group before a capping reaction. By adding the salicylate-based compound in that weight ratio, 80% or more of the terminal hydroxyl groups can be capped advantageously. To carry out this capping reaction, catalysts enumerated in the above US patent are preferably used. The concentration of the terminal hydroxyl group is preferably reduced in a stage before the deactivation of a polymerization catalyst.

In the present invention, the thus obtained aromatic polycarbonate is preferably vacuum treated. The apparatus used for the vacuum treatment is not particularly limited but a reactor equipped with a degassing zone and an extruder equipped with a degassing zone may be used.

The reactor equipped with a degassing zone may be either a vertical tank reactor or a horizontal tank reactor but a horizontal tank reactor is preferred. The extruder equipped with a degassing zone may be either a vented single-screw extruder or double-screw extruder.

The pressure for the vacuum treatment is preferably 0.05 to 750 mmHg (6.7 to 100, 000 Pa), particularly preferably 0.05 to 50 mmHg (6.7 to 6,700 Pa) when a reactor is used and preferably 1 to 750 mmHg (133 to 100,000 Pa), particularly preferably 5 to 700 mmHg (670 to 93,000 Pa) when an extruder is used.

The vacuum treatment is preferably carried out at a temperature of 240 to 350° C. for 5 minutes to 3 hours when a reactor is used and for 10 seconds to 15 minutes when an extruder is used.

The timing of vacuum treating the polycarbonate is not particularly limited. However, when the vacuum treatment is carried out while the activity of the ester exchange catalyst is retained, the degree of polymerization may change or the polymer may deteriorate. Therefore, the vacuum treatment is preferably carried out after or as soon as the above sulfonic acid compound 1) is added and kneaded when a polycarbonate obtained by melt polymerization is used.

When the additives are to be added, the timing of the vacuum treatment is preferably set according to the boiling point of each additive so that the additives can remain in the polymer.

When the vacuum treatment is thus made on the polycarbonate, a polycarbonate having reduced contents of the residual monomer, oligomer and the residual solvent can be obtained. The vacuum treatment may be carried out as required after water, saturated aliphatic hydrocarbon or nitrogen is pressure kneaded with the polycarbonate in order to reduce the contents of the residual monomer, oligomer and the residual solvent.

For instance, when melt polycondensation is carried out using diphenyl carbonate as the carbonic acid diester, the contents of the residual diphenyl carbonate and phenol in the polycarbonate can be reduced by the vacuum treatment. Stated more specifically, the contents (retentions) of diphenyl carbonate and phenol can be each reduced to preferably 0.1 part or less by weight, particularly preferably 0.02 part or less by weight based on 100 parts by weight of the polymer.

A description is subsequently given of the filtration of the thus obtained aromatic polycarbonate. In the present invention, the filtration of the aromatic polycarbonate is an extremely important operation for obtaining a high-quality composition.

The results of researches conducted by the inventors of the present invention have revealed that the deterioration of the aromatic polycarbonate is suppressed and foreign matter contained in the aromatic polycarbonate is removed effectively by specific filtration.

The filter unit used in the present invention is an apparatus for removing foreign matter contained in an aromatic polycarbonate by filtration and comprises an inflow path for guiding the aromatic polycarbonate in a molten state to be filtered to filter elements, filter elements for filtering the aromatic polycarbonate, an outflow path for guiding the filtered aromatic polycarbonate to the outside of the filter, and a vessel for storing these. The filter elements are aromatic polycarbonate filtering means stored in the filter unit.

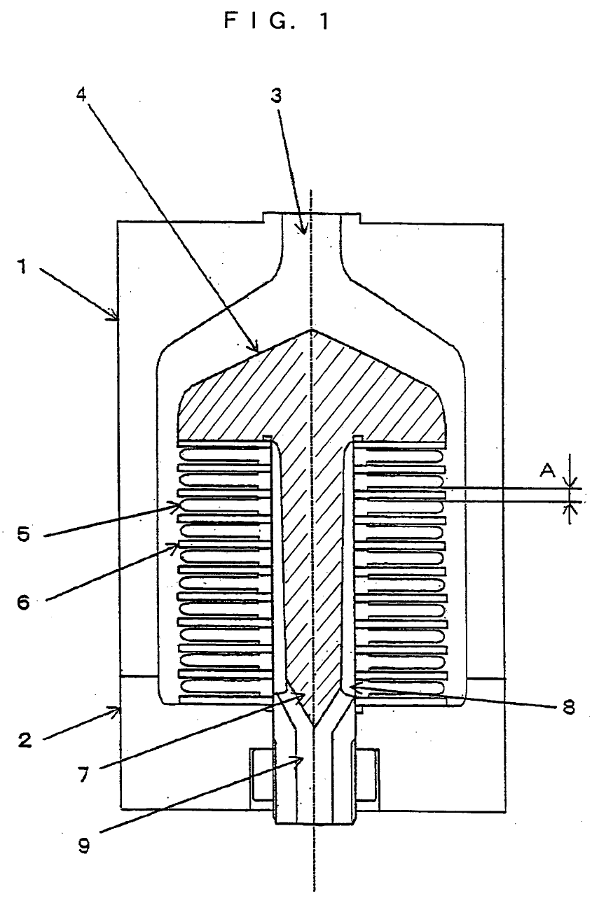

The disk filter elements and filter unit of the present invention will be described hereinbelow with reference to FIGS. 1 to 3. FIGS. 1 to 3 show examples and the present invention is not limited by these figures and a description based on these figures.

FIG. 1 is a sectional view of the filter unit in which disk filter elements 5 are piled up alternately with spacers 6 and pressed against a flange plate 2 by a filter holder 4 to be fixed in a space defined by a filtration vessel 1 and the flange plate 2.

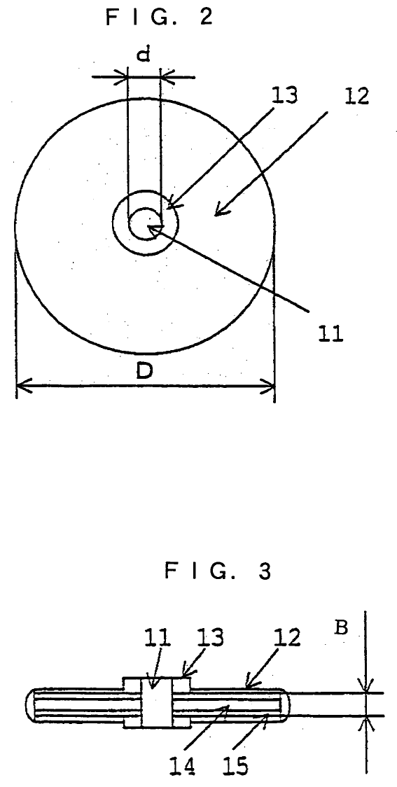

As shown in FIGS. 2 and 3, each of the disk filter elements 5 has a filter medium 12 for filtering a polymer and a hub 13, and the hubs 13 are placed one upon another to form a communication groove 8 consisting of a center pole 7 and an opening 11 when the disk filter elements 5 are piled up together.

The center pole 7 has a polygonal or star-shaped cross section, is inscribed in the opening 11 and serves to determine the assembly position in a radial direction of the disk filter elements 5 and the spacers 6 which are piled up alternately through the center pole 7.

The hubs 13 are pressed against one another or against the flange plate 2 by the filter holder 4 shown in FIG. 1 to be fixed.

The polymer passes through a polymer inflow path 3 and is filtered by the disk filter elements 5, and the filtered polymer passing through the communication groove 8 is discharged to the outside of the filter unit through a polymer outflow path 9.

As shown in FIG. 3, a support plate 15 composed of a punched plate or the like and a retainer 14 composed of a metal net of large meshes or the like are disposed in the interior (secondary flow path) of each disk filter element 5 so that the thickness B of the secondary flow path is prevented from being reduced by pressure at the time of filtration.

The interval between the opposite filtration surfaces of adjacent disk filter elements is expressed by distance A in FIG. 1, the outer diameter of the disk filter element is expressed by distance D, and the inner diameter of the disk filter element is expressed by distance d.

The filter medium 12 of the disk filter element used in the present invention serves to directly remove foreign matter contained in the aromatic polycarbonate, must retain a fixed opening size with a small variation and must have chemical stability to a substance to be treated, heat resistance and a certain measure of pressure resistance. The filter medium is preferably made from a known material which satisfies the above requirements, the most preferably a metal net formed by weaving a metal thin wire or a filter composed of a sintered metal fiber texture produced by forming metal short fibers by a wet or dry process and sintering them to fix the texture.

In the case of an aromatic polycarbonate obtained by melt polymerization, polymerization is carried out continuously in most cases and a polymerizer and a filter unit are directly connected to each other in most cases. Therefore, a trouble with the filter unit may lead to the interruption of the polymerization step. When the filter units are arranged parallel to each other and used by switching, a quality change often occurs at the time of switching. Therefore, the filter unit preferably has a long service life (exactly speaking, service life of the filter element) and a plurality of disk filter elements are preferably used because they can provide a large filtration area when they are assembled together.

Although the disk filter elements can provide a large filtration area, they have such a defect that a drift occurs more easily as the filtration area increases.

Meanwhile, it has been found through studies conducted by the inventors of the present invention that an aromatic polycarbonate itself is easily branched or crosslinked to form a gel due to its long-term heat history even when entry of oxygen is prevented unlike a polyester or polyolefin. Therefore, a drift in the filter unit causes the formation of a gel in the filter unit, which is a fatal problem in the case of an aromatic polycarbonate. Consequently, to make effective use of the disk filter elements for the filtration of the aromatic polycarbonate, this drift problem must be solved.

Based on the above understanding, the inventors of the present invention have conducted intensive studies to find a solution to the above problem and have found that the above drift problem can be solved by satisfying some conditions before use of the disk filter elements, thereby making it possible to obtain a high-quality aromatic polycarbonate containing no gel or foreign matter for a long time using a filter unit.

Any material may be used as the material of the filter unit and the disk filter element if it is inactive with an aromatic polycarbonate obtained by polymerization and contains no component dissolved in the polycarbonate. In general, a metal, particularly stainless steel is used. For example, SUS304, SUS316 and the like are preferably used.

The opening size of the disk filter element in the present invention is the opening diameter of the filter medium of the disk filter element and defined by the grain size (diameter) of spherical grains 95% of which can be collected while they pass through the disk filter element.

In the present invention, the opening size of the disk filter element is 40 μm or less, preferably 20 μm or less, more preferably 10 μm or less. When the opening size of the disk filter element is too large, the amount of foreign matter contained in the obtained polycarbonate increases disadvantageously.

The ratio of the inner diameter to the outer diameter of the disk filter element used in the present invention must be 1/7 or more, preferably 1/5 or more. When the ratio is smaller than 1/7, the difference in filterability between the inner circumferential portion and the outer circumferential portion of each disk filter element becomes marked and a gel is easily formed in the outermost circumferential portion and the innermost circumferential portion disadvantageously.

As is obvious from its definition, the inner diameter/outer diameter ratio does not exceed “1”.

The above phenomenon that a gel is formed by a drift occurs more easily in the outer circumferential portion than the inner circumferential portion. Therefore, a great drift prevention effect is obtained by setting the outer diameter of the disk filter element used to 15 inches (38.1 cm) or less, preferably 12 inches (30.5 cm) or less while the above inner diameter/outer diameter ratio is maintained.

Meanwhile, a larger outer diameter is advantageous from the viewpoint of the filtration area of the disk filter element. From this point of view, the outer diameter of the disk filter element used is preferably 4 inches (10.2 cm) or more, more preferably 6 inches (15.2 cm) or more. Therefore, the disk filter element of the present invention which can prevent a drift and secure a filtration area has an outer diameter of preferably 15 inches (38.1 cm) or less and 4 inches (10.2 cm) or more, more preferably 12 inches (30.5 cm) or less and 6 inches (15.2 cm) or more.

The inner diameter of the disk filter element used in the present invention is not limited if it satisfies the above inner diameter/outer diameter ratio. In the disk filter element, the filtered polymer is generally discharged to the outside of the system through the polymer communication groove 8 formed around the center pole 7 and along the inner end thereof and an excessively small inner diameter generates a large flow resistance. Therefore, the inner diameter is preferably 2 inches (5.08 cm) to 3 inches (7.62 cm).

Since a plurality of disk filter elements are used to form a single filter unit in the present invention, a drift between adjacent disk filter elements is a big problem to be solved.

Also in this case, the formation of a filtration area and the prevention of a drift conflict with each other and a drift easily occurs between adjacent disk filter elements though the filtration area becomes larger as the number of disk filter elements to be assembled together increases.

For the filtration of the present invention, the number of disk filter elements to be assembled together and stored in one filter unit is preferably 500 or less, more preferably 200 or less. When the number of disk filter elements to be assembled together is larger than 500, a drift between adjacent disk filter elements may become marked, the quality of the obtained polymer may deteriorate, and the service life of the filter unit may become short disadvantageously.

To prevent a drift between adjacent disk filter elements and a drift in one disk filter element in the present invention, the interval between adjacent disk filter elements is also important. This interval is preferably substantially 5 mm or less. It is not preferred to narrow the interval unlimitedly. Basically, the lower limit of the interval is preferably determined based on the following idea.

When a flow path through which the polymer before filtration runs is considered as a primary flow path and a flow path through which the polymer after filtration runs is considered as a secondary flow path with the filtration surface as the boundary therebetween, the primary flow path is formed between adjacent disk filter elements out of the disk filter elements assembled together and the secondary flow path is formed within each disk filter element. When the primary flow path is narrow at this point, in other words, the interval is narrower than the flow path formed within each disk filter element, the polymer tends to run into the secondary flow path through a filtration layer from the outer circumferential portion of the primary flow path before it reaches the inner circumferential portion of the primary flow path between adjacent disk filter elements, whereby a dead space is formed in the inner circumferential portion of the disk filter element to form a gel. When the primary flow path is too wide, the opposite phenomenon occurs and a gel is formed in the outer circumferential portion of the disk filter element, thereby causing the deterioration of quality and a reduction in the service life of the filter unit. Therefore, it is ideal that the flow resistance of the primary flow path should be equal to the flow resistance of the secondary flow path. To this end, the interval between adjacent disk filter elements is made substantially equal to the thickness of the secondary flow path formed within each disk filter element as one of standards. Stated more specifically, the difference between the interval and the thickness of the secondary flow path formed within each disk filter element used is desirably ±20% or less of the thickness of the secondary flow path. The thickness of the secondary flow path is thickness B in FIG. 3.

The lower limit is desirably 0.5 mm in consideration of working accuracy.

In the present invention, the expression “the interval between the opposite filtration surfaces of adjacent disk filter elements should be 5 mm or less” means such as described in the following paragraphs (1) to (3).

(1) The interval (distance at 10 points on each filter medium 12) between adjacent disk filter elements is measured at 10 arbitrary points on the filter medium 12 shown in FIG. 2 which are selected such that the intervals therebetween are almost the same, and a set of the obtained measurement values is called “measurement unit”. Therefore, each measurement unit consists of 10 measurement values of the interval at the 10 points.

(2) As for the measurement unit in the above paragraph (1), the measurement unit at least 9 measurement values of which are 5 mm or less is called “measurement unit having an accepted interval”.

(3) When the above measurement (1) is made on all the intervals between adjacent disk filter elements to be stored in one filter unit, the proportion of the number of measurement units having the accepted interval to the total number of measurement units is 90% or more.

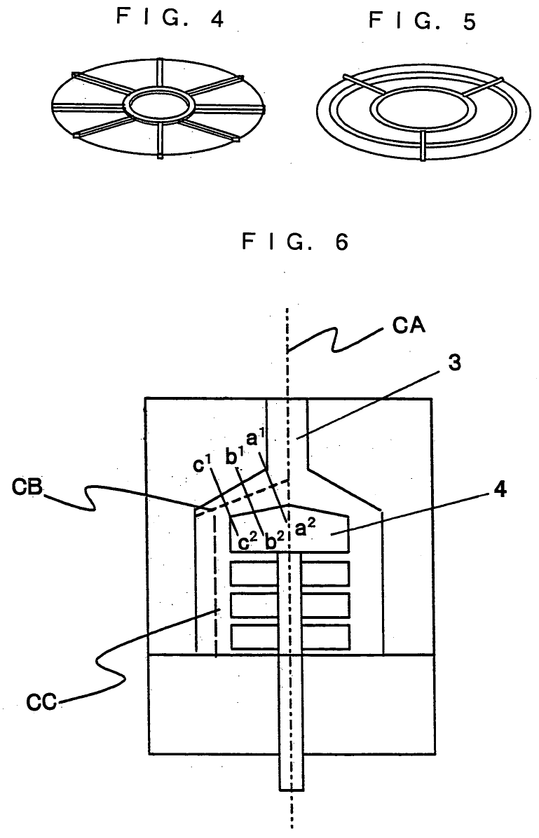

The method of maintaining the above interval at a predetermined value is not particularly limited. For example, as shown in FIG. 1, a radial or concentric spacer 6 made of a wire material having a thickness equal to the above predetermined interval is inserted between adjacent disk filter elements 5. FIG. 4 shows a radial spacer and FIG. 5 shows a concentric spacer.

It is often considered as natural that an aromatic polycarbonate having a low content of foreign matter and excellent quality is obtained by using filter elements having a small opening size for the filtration of a polycarbonate. As a matter of fact, when the opening size is reduced, the quality of the obtained polymer lowers. This is a phenomenon which is closely connected with the feature of an aromatic polycarbonate that a gel is easily formed by the retention of the polymer as described above and occurs due to the expansion of the polymer retention portion of the filter element caused by a reduction in the opening size. Therefore, appropriate operation conditions are required to improve filtration accuracy when filter elements having a small opening size are used.

In the present invention, it is important to control the pressure difference (the difference between the pressure of the inlet and the pressure of the outlet of the filter unit, for example, the difference between the pressure of the polymer inflow path 3 and the pressure of the polymer outflow path 9 in FIG. 1), the throughput per the filtration unit area of the filter elements of the filter unit, the average retention time in the filter unit and the flow velocity of the polymer in the filter unit to optimum values when the filter unit is used and an aromatic polycarbonate having excellent quality can be thereby produced stably using disk filter elements having a small opening size.

In the present invention, it is important to maintain the pressure difference at an optimum value in order to obtain the effect of disk filter elements having a small opening size. The pressure difference in the present invention is preferably 20 kg/cm² or more when disk filter elements having an opening size of 20 μm are used and 40 kg/cm² or more when disk filter elements having an opening size of 10 μm or less are used. When the filter unit is operated at a pressure difference below the above limit, the quality of the obtained polymer does not improve or may deteriorate as the opening size decreases. The upper limit of the pressure difference is usually 150 to 200 kg/cm².

The operation pressure source of the filter unit is generally a gear pump, screw feeder, extruder or the like and not particularly limited in the present invention.

The filtration operation of the present invention is carried out at a polymer temperature of preferably not higher than 350° C., more preferably not higher than 330° C.

In the present invention, to maintain the throughput of the aromatic polycarbonate per the filtration unit area of the disk filter elements at an optimum value is another effective means for obtaining the effect of disk filter elements having a small opening size. The throughput of the polycarbonate per the filtration unit area of the disk filter elements in the present invention is a value obtained by dividing the total amount (kg/hr) of the polymer passing through the disk filter elements by the total filtration area (m²) of the disk filter elements used. In the present invention, this value is preferably set to 50 kg/m²/hr or more, more preferably 100 kg/m²/hr or more, the most preferably 150 kg/m²/hr or more. When the throughput of the aromatic polycarbonate per the filtration unit area of the disk filter elements falls below the above limit, the quality, especially color of the obtained polymer deteriorates and the gel content increases disadvantageously. The upper limit of the throughput of the polycarbonate per unit area is preferably 1,500 to 2,000 kg/m²/hr.

In the present invention, it is preferred to adjust the V/W value to 0.2 to 10 min in order to obtain the effect of disk filter elements having a small opening size.

V represents the space volume of the filter unit, W represents the volume flow rate of the aromatic polycarbonate passing through the filter unit per minute and V/W represents the average retention time of the aromatic polycarbonate passing through the filter unit. When V/W falls below the above lower limit, the filtration operation pressure rises disadvantageously. When V/W exceeds the above upper limit, the color of the obtained polymer worsens disadvantageously. In an extreme case, the gel content may increase.

In the present invention, the flow velocity of the polymer in the filter unit is also an important value to be controlled in order to improve the quality of the obtained aromatic polycarbonate. The flow velocity of the polymer in the filter unit in the present invention is the average flow velocity in the filter unit and a value represented by W×1000/A (cm/min) wherein A is the largest area (cm²) of a polymer flow path in the filtration vessel and W is the flow rate (l/min) of the filtered polymer.

The largest area of a flow path is the largest flow path cross section when the flow path area is measured in a direction perpendicular to the flow direction of the polymer of a flow path through which the polymer to be filtered guided into the filter vessel passes before it reaches the filter. More specifically, it means the largest flow path area out of the cross section of the polymer inflow path 3, the cross section of a flow path formed between the top surface of the filter holder 4 and the inner wall surface opposite thereto of the filter unit, and the cross section of a flow path formed between the periphery of an assembly of a plurality of disk filter elements and the inner wall surface opposite thereto of the filter unit. With reference to the diagram of FIG. 6, the cross section of the polymer inflow path 3 is the cross section in a direction perpendicular to the center line CA of the polymer inflow path. The cross section of the flow path formed between the top surface of the filter holder 4 and the inner wall surface opposite thereto of the filter unit is the cross section of a flow path in a direction perpendicular to the center line CB between the above top surface and the above wall surface, that is, larger one of the areas of ring planes formed by rotating a¹/a² and b¹/b² line segments connecting the top surface and the wall surface in a direction perpendicular to the center line CB on the center line CA as the rotation center axis.

The cross section of the flow path formed between the periphery of the assembly of the plurality of disk filter elements and the inner wall surface opposite thereto of the filter unit is the area of a ring plane formed by rotating a c¹/c² line segment in a direction perpendicular to the center line CC of the flow path on the center line CA as the rotation center axis.

In the present invention, it is important to maintain the average flow velocity of the polymer at a range of 1 to 10,000 cm/min, preferably 10 to 8,000 cm/min, more preferably 50 to 5,000 cm/min. When the average flow velocity of the polymer falls below 1 cm/min, the quality of the obtained polymer deteriorates disadvantageously in most cases. When the average flow velocity exceeds 10,000 cm/min, the operation pressure of filtration becomes too high disadvantageously in most cases.

According to the method 1), the composition of the present invention can be produced by (1) melt polycondensing a dihydroxy compound essentially composed of an aromatic dihydroxy compound and a carbonic acid diester in the presence of an ester exchange catalyst and (2) filtering the obtained aromatic polycarbonate having a viscosity average molecular weight of 10,000 or more with a filter comprising an assembly of a plurality of disk filter elements having an outer diameter of 15 inches (38.1 cm) or less, an inner diameter/outer diameter ratio of 1/7 or more and an opening size of 40 μm or less while it is molten, and directly adding and mixing an inorganic filler (B1) and/or a thermoplastic resin (B2) other than polycarbonates with the obtained molten polycarbonate (A).

The ester exchange catalyst in the step (1) is a combination of (i) 1×10⁻⁵ to 5×10⁻³ chemical equivalent based on 1 mol of the dihydroxy compound of at least one basic compound selected from the group consisting of a basic nitrogen-containing compound and a basic phosphorus-containing compound and (ii) 1×10⁻⁸ to 5×10⁻⁵ chemical equivalent based on 1 mol of the dihydroxy compound of at least one compound selected from the group consisting of an alkali metal compound and an alkali earth metal compound.

Examples of the basic nitrogen-containing compound and the basic phosphorus-containing compound are given hereinabove. To attain the object of the present invention more advantageously, a catalyst containing a rubidium or cesium metal compound (may be referred to as “rubidium metal compound or the like” hereinafter) as the alkali metal compound which is a component of the ester exchange catalyst is preferably used.

The amount of the polymerization catalyst in the present invention is 0.01 to 50 μ-chemical equivalents, preferably 0.02 to 10 μ-chemical equivalents, more preferably 0.05 to 5 μ-chemical equivalents as the total amount of the alkali metal and alkali earth metal compounds based on 1 mol of the aromatic dihydroxy compound. As for the rubidium metal compound or the like, a rubidium metal compound may be used alone but preferably used in conjunction with other alkali metal compound and alkali earth metal compound. In this case, the chemical equivalent ratio of the amount of the rubidium metal compound or the like to the total amount of the alkali metal and alkali earth metal compounds is 0.3 or more, preferably 0.4 or more, more preferably 0.5 or more, particularly preferably 0.7 or more.

The aromatic polycarbonate obtained by melt polymerization is mixed with additives by the above-described method, vacuum treated and filtered with a polymer filter.

The inorganic filler (B1) and/or the thermoplastic resin (B2) other than polycarbonates to be directly added to the molten polycarbonate (A) in the step (2) are the same as those described above.

In the above production process, it is industrially desired that the above step (1) should be carried out with a melt polycondensation apparatus and a twin-screw extruder and a filter installed right after the apparatus and that the above step (2) should be carried out in a melt kneader installed after the step (1). As the apparatus used in the step (2) may be used known kneading method/apparatus but a twin-screw extruder having a plurality of supply ports is preferably used.

In the above production process, after the above additives including a sulfonic acid compound are added to the molten polycarbonate obtained by polymerization, the obtained mixture is filtered as described above and supplied into the extruder while it is molten to be kneaded with the inorganic filler (B1) and the thermoplastic resin (B2) other than aromatic polycarbonates. This production process has an advantage that the heat history of the aromatic polycarbonate is reduced.

When the step (2) is carried out using a twin-screw extruder, the inorganic filler (B1) is preferably supplied into the molten resin from a downstream side of a supply portion for the aromatic polycarbonate (A) or the thermoplastic resin (B2) other than the aromatic polycarbonate. This allows the inorganic filler to be contacted to the extruder segment through the molten resin, thereby making it possible to suppress the undesired size reduction of the inorganic filler and the abrasion of the segment.

As for the supply of the inorganic filler (B1), a predetermined amount of the inorganic filler (B1) is preferably supplied by using a side feeder installed on a downstream side of the aromatic polycarbonate supply portion while the supply is controlled by a quantitative feeder.

The thermoplastic resin (B2) other than the aromatic polycarbonate (A) may be supplied from any position, an upstream or downstream side of the supply position of the aromatic polycarbonate (A) of the present invention, or simultaneous with the aromatic polycarbonate (A) of the present invention. It may be supplied in a solid state directly or after it is molten in a different extruder.

The former is employed in most cases to reduce heat history and simplify the system. For example, the resin (B2) continuously metered by a quantitative feeder is directly supplied into an extruder for the preparation of a composition, or the resin (B2) continuously metered is supplied into an extruder for the preparation of a composition by a side feeder.

In the present invention, the kneading temperature differs according to the type of the thermoplastic resin (B2) other than the polycarbonate but it is generally 200 to 380° C. The supply portion may be sealed up with an inert gas such as nitrogen to prevent entry of oxygen and water or the kneaded composition may be vacuum treated as required.

Alternatively, the composition of the present invention can be produced by (1) filtering an aromatic polycarbonate consisting essentially of a recurring unit represented by the above formula (1) with a filter comprising an assembly of a plurality of disk filter elements having an outer diameter of 15 inches (38.1 cm) or less, an inner diameter/outer diameter ratio of 1/7 or more and an opening size of 40 μm or less while it is molten and pelletizing the obtained aromatic polycarbonate (A) and (2) melting the above pellet and adding and mixing the inorganic filler (B1) and/or the thermoplastic resin (B2) other than the aromatic polycarbonate with the molten pellet.

The pellet of the aromatic polycarbonate prepared in the step (1) is produced by the method described above.

The pellet of the aromatic polycarbonate is preferably vacuum treated but does not need to contain the additives because the additives can be added in the step (2) together with the inorganic filler (B1) and/or the thermoplastic resin (B2) other than the aromatic polycarbonate. Therefore, this alternative process has an advantage that a wide variety of compositions can be produced.

In the alternative process, the step (2) is preferably carried out in a melt extruder. The method of adding the inorganic filler (B1) and/or the thermoplastic resin (B2) other than the aromatic polycarbonate and the position of adding these are the same as in the above process.

The aromatic polycarbonate composition of the present invention can be formed into a molded article having excellent durability and stability by a molding technique such as injection molding.

The aromatic polycarbonate composition of the present invention is excellent in the surface properties and transferability of its molded article due to a low content of foreign matter as well as mechanical properties such as impact resistance. Since it is particularly excellent in the effect of retaining long-term durability under extreme temperature and humidity conditions, it can be formed into various molded articles such as substrates for optical information recording media and sheets for various applications. For example, substrates for high-density optical disks typified by Compact disk (CD), CD-ROM, CD-R, CD-RW, magneto-optical disks (MO) and digital versatile disks (such as DVD-ROM, DVD-Video, DVD-Audio, DVD-R and DVD-RAM) obtained from the composition have high reliability for a long time. It is particularly useful for high-density optical disks such as digital versatile disks.

The sheets obtained from the aromatic polycarbonate composition of the present invention are excellent in flame retardancy, antistatic properties, adhesion and printability and widely used in electric parts, building material parts and auto parts thanks to the above characteristic properties. More specifically, they are used in glazing products for window materials, that is, window materials for general houses, gyms, baseball domes and vehicles (such as construction machinery, automobiles, buses, bullet trains and electric vehicles), side wall panels (such as sky domes, top lights, arcades, wainscots for condominiums and side panels on roads), window materials for vehicles, displays and touch panels for OA equipment, membrane switches, photo covers, polycarbonate resin laminate panels for water tanks, front panels and Fresnel lenses for projection TVs and plasma displays, and such optical applications as optical cards, liquid crystal cells consisting of an optical disk and a polarizer, and phase difference compensators. The thickness of the sheet of the aromatic polycarbonate composition does not need to be particularly limited but it is generally 0.1 to 10 mm, preferably 0.2 to 8 mm. Particularly a thin sheet is advantageous. Various processing treatments for providing new functions (such as lamination for improving weatherability, a treatment for improving scratch resistance, surface drawing and processing for making translucent or opaque) may be carried out on the sheet of the aromatic polycarbonate composition.

The thus obtained aromatic polycarbonate composition can be formed into a sheet in accordance with a commonly used method and, for example, a melt extrusion method is preferably used.

The following examples are given to further illustrate the present invention.

### EXAMPLES

1) intrinsic viscosity [η] of polycarbonate;

It was measured in methylene chloride at 20° C. using an Ubbellohde viscometer. The viscosity average molecular weight was calculated from the intrinsic viscosity according to the following equation.

[η]=1.23×10⁻⁴ Mw^{0.83}

2) concentration of terminal group;

0.02 g of a sample was dissolved in 0.4 ml of chloroform deuteride to measure a terminal hydroxyl group and the concentration thereof using ¹H-NMR (EX-270 of JEOL LTD.) at 20° C.

### Example 1 (Production of PC-1, 2)

An aromatic polycarbonate was produced as follows.

A polymerization system comprising a raw material preparation tank, a raw material feed tank, a catalyst preparation tank, a catalyst feed tank, a first pre-polymerization tank, a second pre-polymerization tank, a post-polymerization tank and a twin-screw extruder was used to produce an aromatic polycarbonate. The first pre-polymerization tank and the second pre-polymerization tank of the system were vertical agitation tanks equipped with a fractionating column and the post-polymerization tank was a horizontal single-axis agitation tank.

A raw material mixture obtained by mixing and melting bisphenol A and diphenyl carbonate in a molar ratio of 1:1.03 was supplied into the first pre-polymerization tank at a rate of 194 kg/hr, a catalyst solution prepared by dissolving bisphenol A disodium salt in a mixed solvent of phenol and water (weight ratio of 90/10) to a concentration of 30 ppm was supplied into the first pre-polymerization tank at a rate of 1.11 kg/hr, the first pre-polymerization tank was maintained at 230° C. and 100 Torr (13,300 Pa), the second pre-polymerization tank was maintained at 260° C. and 15 Torr (1.995 Pa) and the post-polymerization tank was maintained at 270° C. and 1 Torr (133 Pa) to carry out polymerization continuously, and then the obtained polycarbonate was supplied into the double-screw extruder. The used vented double-screw extruder was a unidirectional roating intermeshed twin-screw extruder having 5 processing zones each consisting of a kneading portion and a vent portion.

In the first processing zone of the extruder, tetrabutylphosphonium dodecylbenzenesulfonate dispersed in water was continuously supplied into the kneading portion as a sulfonic acid compound using a diaphragm quantitative pump to ensure that the amount of the dispersion should become 1 wt % based on the polymer and the amount of the tetrabutylphosphonium dodecylbenzenesulfonate should become 2 times the equivalent of the bisphenol A disodium salt used as a polymerization catalyst and kneaded with the polycarbonate and then the obtained mixture was vacuum treated at 15 Torr (1,995 Pa) in the vent portion right after the kneading portion through a material seal to remove water used as a solvent.

In the second, third and fourth processing zones, 1 wt % based on the polymer of water was continuously supplied into the kneading portions thereof using diaphragm quantitative pumps and then the polymer was vacuum treated at 15 Torr (1,995 Pa) in the vent portions right after the kneading portions through a material seal to remove phenol and DPC contained in the polycarbonate together with water.

In the fifth processing zone, a polycarbonate powder containing5,000ppm of tris(2,4-di-t-butylphenyl)phosphite as a phosphorus compound and 50,000 ppm of monoglyceride stearate as an ester of an aliphatic alcohol and an aliphatic carboxylic acid was continuously added in an amount of 1 wt % based on the polymer using a side feeder and kneaded with the polycarbonate and then the mixture was vacuum treated at 15 Torr in the vent portion.

The polycarbonate mixed with the above additives and having a viscosity average molecular weight of 15,200 was continuously extruded from the extruder at a rate of 110 kg/hr and supplied to a polymer filter after the pressure was raised by a gear pump. The density of the polycarbonate was 1.08 g/cm³ and the volume flow rate thereof was 102 l/hr (1.7l/min). The used polymer filter was constructed by assembling together three SUS316 disk filter elements having an opening size of 20 μm, an inner diameter/outer diameter ratio of 1/4.8 and an outer diameter of 12 inches (30.5 cm) at intervals of 1.5 mm and mounting the assembly to a filter unit having a total volume of 2.7 l. The throughput of the polycarbonate per the filtration unit area of the disk filter elements was 263 kg/m²/hr, V/W was 1.6 min (V is the inside volume (1) of the filtration vessel and W is the flow rate (l/min) of the filtered polymer), and W×1,000/A was 17.2 cm/min. The pressure difference under the above conditions was 40 kgf/cm². The obtained polycarbonate contained 20 ppm of phenol and 80 ppm of DPC as low-boiling components, 1,200 foreign substances as large as 0.5 μm or more per g and 0 to 1 foreign substance as large as 30 μm or more per kg excluding a gel and had a color b value of −0.5 and an OH terminal content of 20 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 0 to 2 gels per kg.

This polycarbonate was extruded from a die to be pelletized (PC-2) or molten (PC-1).

### Example 2 (Production of PC-3)

An aromatic polycarbonate was produced in the same manner as in Example 1 except that a polycarbonate powder containing no phosphorus compound and no ester of an aliphatic alcohol and an aliphatic carboxylic acid was added in an amount of 1 wt % based on the polymer in the fifth processing zone of the extruder and the resulting mixture was pelletized as PC-3. PC-3 was a polycarbonate which contained tetrabutylphosphonium dodecylbenzenesulfonate as a sulfonic acid compound and was vacuum treated and filtered according to the method of the present invention. PC-3 contained 18 ppm of phenol and 83 ppm of DPC as low-boiling components, 1,100 foreign substances as large as 0.5 μm or more per g and 0 to 1 foreign substance as large as 30 μm or more per kg excluding a gel and had a color b value of −0.5 and an OH terminal content of 20 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 0 to 2 gels per kg.

### Example 3 (Production of PC-4)

The same polymerization system as in Example 1 was used to carry out polymerization, addition of additives and vacuum treatment continuously under the same conditions as in Example 1, 70 kg/hr of the polycarbonate was extracted from the double-screw extruder, and the remaining 40 kg/hr (37 l/hr=0.617 l/min) of the polycarbonate was supplied to the same polymer filter as in Example 1 to be filtered. The throughput of the polycarbonate resin per the unit area of the filter was 96 kg/m²/hr, V/W (V: the inside volume (1) of the filtration vessel, W: the flow rate (l/min) of the filtered polymer) was 4.4 min and W×1,000/A was 6.3 cm/min. The pressure difference under the above conditions was 15 kgf/cm².

The obtained polycarbonate contained 25 ppm of phenol and 80 ppm of DPC as low-boiling components, 1,550 foreign substances as large as 0.5 μm or more per g and 1 to 5 foreign substances as large as 30 μm or more per kg excluding a gel and had a color b value of −0.3 and an OH terminal content of 20 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 5 to 10 gels per kg.

This polycarbonate was extruded from a die to be pelletized (PC-4).

### Comparative Example 1 (Production of PC-5, 6)

The same polymerization system as in Example 1 was used to carry out polymerization, addition of additives and vacuum treatment continuously under the same conditions as in Example 1, a polycarbonate containing tetrabutylphosphonium dodecylbenzenesulfonate as a sulfonic acid compound, tris(2,4-di-t-butylphenyl)phosphite as a phosphorus compound and monoglyceride stearate as an ester of an aliphatic alcohol and an aliphatic carboxylic acid and having a viscosity average molecular weight of 15,200 was continuously extruded from the extruder at a rate of 110 kg/hr and supplied to a polymer filter after the pressure was raised by a gear pump. The polymer filter constructed by assembling together three SUS316 disk filter elements having an opening size of 20 μm, an inner diameter/outer diameter ratio of 1/12 and an outer diameter of 24 inches (61.0 cm) at intervals of 1.5 mm and mounting the assembly to a filter unit having a total volume of 11 l was used in place of the polymer filter of Example 1. The throughput of the polycarbonate per the unit area of the disk filter elements was 63 kg/m²/hr, V/W (V: the inside volume (1) of the filtration vessel, W: the flow rate (l/min) of the filtered polymer) was 6.5 min and W×1,000/A was 8.7 cm/min. The initial pressure difference under the above conditions was 10 kgf/cm².

The obtained polycarbonate contained 40 ppm of phenol and 85 ppm of DPC as low-boiling components, 9,000 foreign substances as large as 0.5 μm or more per g and 40 foreign substances as large as 30 μm or more per kg excluding a gel and had a color b value of 0.1 and an OH terminal content of 20 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 80 gels per kg.

This polycarbonate was extruded from a die to be pelletized (PC-6) or molten (PC-5).

### Example 4 (Production of PC-7, 8)

A polycarbonate was produced in the same manner as in Example 1 except that in the polymerization system as in Example 1, a second post-polymerization tank was installed between the post-polymerization tank and the double-screw extruder to supply the polycarbonate obtained from the post-polymerization tank to the second post-polymerization tank to further carry out polymerization and then supply the polycarbonate to the double-screw extruder. A horizontal self-cleaning double-screw reactor was used as the second post-polymerization tank.

A raw material mixture obtained by mixing and melting bisphenol A and diphenyl carbonate in a molar ratio of 1:1.01 was supplied to the first pre-polymerization tank at a rate of 192 kg/hr, a catalyst solution prepared by dissolving bisphenol A disodium salt in a mixed solvent of phenol and water (weight ratio of 90/10) to a concentration of 30 ppm was supplied to the first pre-polymerization tank at a rate of 1.11 kg/hr, the first pre-polymerization tank was maintained at 230° C. and 100 Torr (13,300 Pa), the second pre-polymerization tank at 260° C. and 15 Torr (1,995 Pa), the post-polymerization tank at 270° C. and 1 Torr and the second post-polymerization tank at 285° C. and 0.8 Torr (106 Pa) to continuously carry out polymerization, and then the obtained polycarbonate was supplied to the double-screw extruder. The used vented double-screw extruder was a unidirectional rotating intermeshed twin-screw extruder having two processing zones each consisting of a kneading portion and a vent portion.

In the first processing zone of the extruder, tetrabutylphosphonium dodecylbenzenesulfonate dispersed in water was continuously supplied into the kneading portion as a sulfonic acid compound using a diaphragm quantitative pump to ensure that the amount of the dispersion should become 1 wt % based on the polymer and the amount of the tetrabutylphosphonium dodecylbenzenesulfonate should become 2 times the equivalent of the bisphenol A disodium salt used as a polymerization catalyst and kneaded with the polycarbonate and then the resulting mixture was vacuum treated at 15 Torr (1,995 Pa) in the vent portion right after the kneading portion through a material seal to remove water used as a solvent.

In the second processing zone, a polycarbonate powder containing 10,000 ppm of tris(2,4-di-t-butylphenyl)phosphite as a phosphorus compound and 100,000 ppm of monoglyceride stearate as an ester of an aliphatic alcohol and an aliphatic carboxylic acid was continuously added in an amount of 1 wt % based on the polymer using a side feeder and kneaded with the polycarbonate and then the resulting mixture was vacuum treated at 15 Torr in the vent portion.

The polycarbonate mixed with additives and having a viscosity average molecular weight of 24,000 was continuously extruded from the extruder at a rate of 110 kg/hr and supplied to a polymer filter at 310° C. after the pressure was raised by a gear pump. The density of the polycarbonate was 1.08 g/cm³ and the volume flow rate thereof was 102 l/hr (1.7 l/min). The used polymer filter was constructed by assembling together three SUS316 disk filter elements having an opening size of 40 μm, an inner diameter/outer diameter ratio of 1/2.7 and an outer diameter of 8 inches (20.3 cm) at intervals of 1.9 mm and mounting the assembly to a filter unit having a total volume of 1.8 l. The throughput of the polycarbonate per the filtration unit area of the disk filter elements was 659 kg/m²/hr, V/W (V: the inside volume (1) of the filtration vessel, W: the flow rate (l/min) of the filtered polymer) was 1.1 min, and W×1,000/A was 23 cm/min. The pressure difference under the above conditions was 100 kgf/cm².

The obtained polycarbonate contained 15 ppm of phenol and 100 ppm of DPC as low-boiling components, 2,500 foreign substances as large as 0.5 μm or more per g and 10 to 20 foreign substances as large as 30 μm or more per kg excluding a gel and had a color b value of −0.1 and an OH terminal content of 30 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 5 to 10 gels per kg.

This polycarbonate was extruded from a die to be pelletized (PC-8) or molten (PC-7).

### Example 5 (Production of PC-9)

Polymerization was carried out in the same manner as in Example 4 except that a polycarbonate powder containing no tris (2,4-di-t-butylphenyl)phosphite and no monoglyceride stearate was added in an amount of 1 wt % based on the polymer by a side feeder and the obtained polycarbonate was extruded from a die to be pelletized (PC-9).

The obtained polycarbonate contained tetrabutylphosphonium dodecylbenzenesulfonate as a sulfonic acid compound, 13 ppm of phenol and 100 ppm of DPC as low-boiling components, 2,400 foreign substances as large as 0.5 μm or more per g and 10 to 20 foreign substances as large as 30 μm or more per kg excluding a gel and had a color b value of −0.1 and an OH terminal content of 30 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 5 to 10 gels per kg.

### Comparative Example 2 (Production of PC-10, 11)

The same polymerization system as in Example 4 was used to carry out polymerization, addition of additives and vacuum treatment continuously under the same conditions as in Example 4, a polycarbonate containing tetrabutylphosphonium dodecylbenzenesulfonate as a sulfonic acid compound, tris(2,4-di-t-butylphenyl)phosphite as a phosphorus compound and monoglyceride stearate as an ester of an aliphatic alcohol and an aliphatic carboxylic acid and having a viscosity average molecular weight of 24,000 was continuously extruded from the extruder at a rate of 110 kg/hr, 30 kg/hr of the polycarbonate was discharged, and the remaining 80 kg/hr of the polycarbonate was supplied to a polymer filter at 310° C. after the pressure was raised by a gear pump. The polymer filter constructed by assembling together three SUS316 disk filter elements having an opening size of 40 μm, an inner diameter/outer diameter ratio of 1/12 and an outer diameter of 24 inches (61.0 cm) at intervals of 1.5 mm and mounting the assembly to a filter unit having a total volume of 11 l was used in place of the polymer filter of Example 4. The throughput of the polycarbonate per the filtration unit area of the disk filter elements was 46 kg/m²/hr, V/W (V: the inside volume (1) of the filtration vessel, W: the flow rate (l/min) of the filtered polymer) was 8.9 min and W×1,000/A was 6.3 cm/min. The initial pressure difference under the above conditions was 18 kgf/cm².

The obtained polycarbonate contained 15 ppm of phenol and 100 ppm of DPC as low-boiling components, 15,000 foreign substances as large as 0.5 μm or more per g and 85 foreign substances as large as 30 μm or more per kg excluding a gel and had a color b value of 0.8 and an OH terminal content of 30 mol %. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 120 to 150 gels per kg.

This polycarbonate was extruded from a die to be palletized (PC-11) or molten (PC-10).

### Example 6 (Production of PC-12)

A polycarbonate powder produced by reacting bisphenol A with phosgene in the presence of p-tert-butylphenol as a terminal capping agent in accordance with the interfacial polymerization process, containing no additives and having an OH terminal content of 5 mol % and a viscosity average molecular weight of 24,000 was supplied into a unidirectional rotating intermeshed twin-screw extruder having two processing zones each consisting of a kneading portion and a vent portion at a rate of 110 kg/hr to be molten. In the first processing zone of the extruder, ion exchange water was supplied in an amount of 1 wt % based on the polymer and kneaded with the above polycarbonate, and the resulting mixture was vacuum treated at 15 Torr (1,995 Pa) in the vent portion right after the kneading portion through a material seal to remove low-boiling substances contained in the polymer together with water.

In the second processing zone, a polycarbonate powder containing 10,000 ppm of tris(2,4-di-t-butylphenyl)phosphite as a phosphorus compound and 100,000 ppm of monoglyceride stearate as an ester of an aliphatic alcohol and an aliphatic carboxylic acid was continuously added in an amount of 1 wt % based on the polymer by a side feeder and kneaded with the polycarbonate and then the resulting mixture was vacuum treated at 15 Torr (1,995 Pa) in the vent portion.

The polycarbonate mixed with the additives was continuously extruded from the extruder at a rate of 110 kg/hr and supplied to a polymer filter at 310° C. after the pressure was raised by a gear pump. The density of the polycarbonate was 1.08 g/cm³ and the volume flow rate thereof was 102 l/hr (1.7 l/min). The used polymer filter was constructed by assembling together three SUS316 disk filter elements having an opening size of 40 μm, an inner diameter/outer diameter ratio of 1/2.7 and an outer diameter of 8 inches (20.3 cm) at intervals of 1.9 mm and mounting the assembly to a filter unit having a total volume of 1.8 l. The throughput of the polycarbonate per the filtration unit area of the disk filter elements was 659 kg/m²/hr, V/W (V: the inside volume (1) of the filtration vessel, W: the flow rate (l/min) of the filtered polymer) was 1.1 min, and W×1,000/A was 23 cm/min. The pressure difference under the above conditions was 102 kgf/cm².

The obtained polycarbonate contained 2 ppm in terms of chlorine of methylene chloride phenol as a low-boiling component, 3,200 foreign substances as large as 0.5 μm or more per g and 10 to 20 foreign substances as large as 30 μm or more per kg excluding a gel and had a color b value of 0.1. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 2 to 5 gels per kg.

This polycarbonate was extruded from a die to be pelletized (PC-12).

### Comparative Example 3 (Production of PC-13)

A polycarbonate powder prepared by the same interfacial polymerization process as in Example 6 was supplied into a unidirectional rotating intermeshed twin-screw extruder having two processing zones each consisting of a kneading portion and a vent portion at a rate of 80 kg/hr to be molten. In the first processing zone of the extruder, ion exchange water was supplied in an amount of 1 wt % based on the polymer and kneaded with the polycarbonate and then the resulting mixture was vacuum treated at 15 Torr (1,995 Pa) in the vent portion right after the kneading portion through a material seal to remove low-boiling substances contained in the polymer together with water.

In the second processing zone, a polycarbonate powder containing 10,000 ppm of tris(2,4-di-t-butylphenyl)phosphite as a phosphorus compound and 100,000 ppm of monoglyceride stearate as an ester of an aliphatic alcohol and an aliphatic carboxylic acid was continuously added in an amount of 1 wt % based on the polymer by a side feeder and kneaded with the polycarbonate and then the resulting mixture was vacuum treated at 15 Torr (1,995 Pa) in the vent portion.

The polycarbonate mixed with the additives was continuously extruded from the extruder at a rate of 80 kg/hr and supplied to a polymer filter at 310° C. after the pressure was raised by a gear pump. The polymer filter constructed by assembling together three SUS316 disk filter elements having an opening size of 40 μm, an inner diameter/outer diameter ratio of 1/12 and an outer diameter of 24 inches (61.0 cm) at intervals of 1.5 mm and mounting the assembly to a filter unit having a total volume of 11 l was used in place of the polymer filter of Example 6. The throughput of the polycarbonate per the filtration unit area of the disk filter elements was 46 kg/m²/hr, V/W (V: the inside volume (1) of the filtration vessel, W: the flow rate (l/min) of the filtered polymer) was 8.9 min, and W×1,000/A was 6.3 cm/min. The initial pressure difference under the above conditions was 18 kgf/cm².

The obtained polycarbonate contained 2 ppm in terms of chlorine of methylene chloride as a low-boiling component, 19,000 foreign substances as large as 0.5 μm or more per g and 65 foreign substances as large as 30 μm or more per kg excluding a gel and had a color b value of 0.9. 1 kg of the polymer was dissolved in 10 kg of methylene chloride, the resulting solution was filtered with a filter cloth having an opening size of 20 μm, and the filter cloth was observed through a microscope under the irradiation of ultraviolet radiation to count the number of gels. It was 80 to 100 gels per kg.

This polycarbonate was extruded from a die to be palletized (PC-13).

### Reference Example 1 (Sheet Evaluation Example)

The above polymers PC-8, 11, 12 and 13 were molten and quantitatively supplied to the T die of a molding machine by a gear pump. Each of the polycarbonates was melt extruded to form a sheet having a thickness of 2 mm or 0.2 mm and a width of 800 mm while it was sandwiched between a mirror surface cooling roll and a mirror surface roll, or touched on one side.

The number of foreign matter defects per 1 m² of each of the obtained aromatic polycarbonate sheets was counted with the naked eye and the number of defects which emitted light with ultraviolet radiation was counted as the number of gel defects.

A visible light curable plastic adhesive (BENEFIX PC of Ardel Co., Ltd.) was applied to one side of the obtained aromatic polycarbonate sheet (thickness of 2 mm) which was then assembled with the same polycarbonate sheet while they were pressed in one direction such that air bubbles should not be contained therebetween, and the bonding strength of a laminate obtained by exposing the assembly to 5,000 mJ/cm² of visible radiation from an optical curing device equipped with a metal halide lamp for visible right was measured in accordance with JIS K-6852 (compression shear bonding strength testing method for adhesives).

Meanwhile, the obtained 0.2 mm-thick aromatic polycarbonate sheet was printed with a uniform solution prepared by mixing ink (Natsuda 70-9132: 136D smoke color) with a solvent (isophorone/cyclohexane/isobutanol=40/40/20 (wt %)) by a silk screen printer and dried at 100° C. for 60 minutes. The existence of a transfer failure was observed. The results are shown in Table 1.

TABLE 1

| | Sample | | | |
|---|---|---|---|---|
| | PC-8 | | PC-11 | |
| Thickness of sheet | 2 | 0.2 | 2 | 0.2 |
| (mm) | | | | |
| The number of foreign | 14 | 21 | 39 | 220 |
| matter defects | | | | |
| Number of gel defects | 1 | 1 | 6 | 156 |
| Bonding strength of | 11.2 | — | 8.6 | — |
| laminate (Mpa) | | | | |
| Printability | — | satisfactory | — | unsatisfactory |
| | Sample | | | |
| | PC-12 | | PC-13 | |
| Thickness of sheet | 2 | 0.2 | 2 | 0.2 |
| (mm) | | | | |
| The number of foreign | 12 | 20 | 35 | 200 |
| matter defects | | | | |
| Number of gel defects | 1 | 1 | 5 | 137 |
| Bonding strength of | 11.5 | — | 8.8 | — |
| laminate (Mpa) | | | | |
| Printability | — | satisfactory | — | unsatisfactory |

### Examples 7 to 13 (Evaluation of Polymer Blend Compound)

Compounds were prepared by mixing PC-8 with components shown in Tables 2 and 3 in ratios shown in these tables using a vented double-screw extruder equipped with a side feeder. A predetermined amount of PC-8 was supplied from a feed portion at the uppermost stream of the double-screw extruder and molten at a cylinder temperature of 260° C., and predetermined amounts of the components were supplied from a downstream of the melting zone using the side feeder and kneaded with PC-8, and the resulting mixtures were pelletized while they were degassed at a vacuum degree of 1.33 kPa (10 mmHg). The obtained pellets were dried at 120° C. for 5 hours and injection molded into a molded piece for measurement at a cylinder temperature of 270° C. and a mold temperature of 800 C by an injection molding machine (SG150U of Sumitomo Heavy Industries, Ltd.) to carry out the following evaluations. The results are shown in Tables 1 and 2. Symbols in Tables 1 and 2 represent the following components.

(1)-1 ABS: styrene-butadiene-acrylonitrile copolymer; Suntac UT-61 (of Mitsui Chemicals, Inc.)

(1)-2 AS: styrene-acrylonitrile copolymer; Stylac-AS 767 R27 (of Asahi Chemical Industry Co., Ltd.)

(1)-3 PET: polyethylene terephthalate; TR-8580 (of Teijin Limited, intrinsic viscosity of 0.8)

(1)-4 PBT: polybutylene terephthalate; TRB-H (of Teijin Limited, intrinsic viscosity of 1.07)

(2)-1 MBS: methyl (meth)acrylate-butadiene-styrene copolymer; Kaneace B-56 (of Kaneka Corporation)

(2)-2 Z-1: butadiene-alkyl acrylate-alkyl methacrylate copolymer; Paraloid EXL-2602 (of Kureha Chemical Industry Co., Ltd.)

(2)-3 Z-2: composite rubber in which a polyorganosiloxane component and polyalkyl (meth)acrylate rubber component form a mutual penetration network structure; Metabrene S-2001 (of Mitsubishi Rayon Co., Ltd.)

(3)-1 T: talc; HS-TO.8 (of Hayashi Kasei Co., Ltd., average particle diameter L measured by a laser diffraction method=5 μm, L/D=8)

(3)-2 G: glass fiber; chopped strand ECS-03T-511 (of Nippon Electric Glass Co., Ltd., urethane bundling, fiber diameter of 13 μm)

(3)-3 W: wollastonite; Saikatec NN-4 (of Tomoe Kogyo Co., Ltd., number-average fiber diameter D obtained by observation through an electron microscope=1.5 μm, average fiber length=17 μm, aspect ratio L/D=20)

(4) WAX: olefin-based wax obtained by copolymerizing α-olefin with maleic anhydride; Diayacalna-P30 (of Mitsubishi Kasei Corporation) (content of maleic anhydride=10 wt %)) physical property evaluation items

(A) Flexural Modulus

The flexural modulus was measured in accordance with ASTM D790.

(B) Notched Impact Value

A 3.2 mm-thick test sample was used and a weight was stricken against the test sample from the notch side to measure its impact value in accordance with ASTM D256.

(C) Flowability

The flowability was measured with an Archimedes type spiral flow meter (a thickness of 2 mm and a width of 8 mm) at a cylinder temperature of 250° C., a mold temperature of 80° C. and an injection pressure of 98.1 MPa.

(D) Chemical Resistance

1% of strain was applied to a tensile test sample in accordance with ASTM D638 and the test sample was immersed in Esso regular gasoline at 30° C. for 3 minutes to measure its tensile strength and calculate its retention. The retention was calculated from the following equation.

Retention (%)=(strength of treated sample/strength of untreated sample)×100

TABLE 2

| | | | Ex. 7 | Ex. 8 | Ex. 9 | Ex. 10 |
|---|---|---|---|---|---|---|
| Composition | Polycarbonate PC-8 | wt % | 60 | 60 | 60 | 60 |
| | ABS | wt % | 40 | 40 | 40 | |
| | AS | wt % | | | | 30 |
| | MBS | wt % | | | | 10 |
| | Total | wt % | 100 | 100 | 100 | 100 |
| | G | parts by weight | 15 | | | 15 |
| | W | parts by weight | | 15 | | |
| | T | parts by weight | | | 15 | |
| | WAX | parts by weight | | 1 | 1 | |
| Characteristic | Flexural modulus | MPa | 3,400 | 3,150 | 2,910 | 3,280 |
| properties | Flowability | cm | 31 | 27 | 30 | 35 |
| | Notched impact resistance | J/m | 83 | 73 | 55 | 88 |

Ex.: Example

TABLE 3

| | | | Ex. 11 | Ex. 12 | Ex. 13 |
|---|---|---|---|---|---|
| Composition | Polycarbonate PC-8 | wt % | 70 | 70 | 70 |
| | PBT | wt % | | 30 | 5 |
| | PET | wt % | 30 | | 25 |
| | Total | wt % | 100 | 100 | 100 |
| | Z-1 | parts by weight | 5 | 5 | |
| | Z-2 | parts by weight | | | 5 |
| | G | parts by weight | 20 | | |
| | W | parts by weight | | 10 | |
| | T | parts by weight | | | 10 |
| | WAX | parts by weight | | 1 | 1 |
| Characteristic | Flexural modulus | MPa | 5,800 | 3,600 | 3,450 |
| properties | chemical resistance | % | 90 | 87 | 85 |
| | Notched impact resistance | J/m | 225 | 545 | 521 |

Ex.: Example

### Example 14 and Comparative Example 4 (Evaluation of Polymer Blend Compound)

Compounds were prepared in the same manner as in Example 8 except that PC-7 and PC-10 were used in place of PC-8 and their characteristic properties were evaluated. PC-7 and PC-10 in a molten state were directly supplied to a twin-screw extruder for the preparation of compounds. The results are shown in Table 4.

TABLE 4

| | | | Ex. 14 | C.Ex. 4 |
|---|---|---|---|---|
| | Kind of Polycarbonate | | PC-7 | PC-10 |
| Composition | Polycarbonate | wt % | 60 | 60 |
| | ABS | wt % | 40 | 40 |
| | Total | wt % | 100 | 100 |
| | G | parts by | 15 | 15 |
| | | weight | | |
| Characteristic | Flexural modulus | MPa | 3,450 | 3,380 |
| properties | chemical resistance | % | 31 | 31 |
| | Notched impact resistance | J/m | 86 | 69 |

Ex.: Example
C.Ex. Comparative Example

### Example 15 (Evaluation of Polymer Blend Compound)

A compound was prepared in the same manner as in Example 8 except that PC-9 was used in place of PC-8 and a polycarbonate powder containing 10,000 ppm of tris(2,4-di-t-butylphenyl)phosphite as a phosphorus compound and 100,000 ppm of monoglyceride stearate as an ester of an aliphatic alcohol and an aliphatic carboxylic acid was supplied to a twin-screw extruder for the preparation of a compound in an amount of 1 wt % based on PC-9 together with PC-9 and the characteristic properties of the obtained compound were evaluated. As a result, the compound had a flexural modulus of 3,400 MPa, a chemical resistance of 30% and a notched impact strength of 80 J/m.

### Reference Examples 2 and 3 and Comparative Reference Example 1 (Molding of Disk)

Optical disk substrates were molded from PC-2, PC-4 and PC-6 and their characteristic properties were evaluated. The results are shown in Table 5.

Production of Dummy Substrate

A DVD mold was mounted to the injection molding machine (DISK3MIII) of Sumitomo Heavy Industries, Ltd., a nickel DVD stamper having a pit was set on this mold, and a molding material was supplied into the hopper of the molding machine automatically to carry out molding at a cylinder temperature of 375° C. and a mold temperature of 110° C.

Production of Data Substrate

A1 was sputtered on one side of a substrate injection molded in the same manner as the dummy substrate to produce a data substrate.

Assembly of Substrates

An ultraviolet light curable resin (KAYARAD DVD-003 of Nippon Kayaku Co., Ltd.) was applied to the inner circumferential portion of the dummy substrate which was then assembled with the data substrate. The obtained laminate was turned at a high speed to spread the applied ultraviolet light curable resin to the outer circumferential portion and the ultraviolet light curable resin was cured with an UV irradiating device to produce a laminated optical disk.

Measurement of Errors

The number of PO errors which occurred in the laminated disk was measured with a DVD error measuring instrument (DR-3350 of Kenwood TMI Co., Ltd.). The measurement was made on 100 disks and the measurement values were averaged.

Long-Term Reliability Test

An optical disk substrate (diameter: 120 mm, thickness: 1.2 mm) molded by the injection molding machine (DISK3MIII) of Sumitomo Heavy Industries, Ltd. was left in a thermohydrostat controlled to a temperature of 80° C. and a relative humidity of 85% for 1,000 hours and the number of white points as large as 20 μm or more formed in the substrate was counted. This was made on 25 substrates and the measurement values were averaged.

Color of Substrate

The colors of the obtained substrates were evaluated visually.

TABLE 5

| | R.Ex. 2 | R.Ex. 3 | C.R.Ex. 1 |
|---|---|---|---|
| Used PC | PC-2 | PC-4 | PC-6 |
| Color of substrate | achromatic and | achromatic and | light yellow and |
| | transparent | transparent | transparent |
| Number of PO | 0 | 1.7 | 6.5 |
| errors | | | |
| Number of white | 0.2 | 0.8 | 4.6 |
| points | | | |

R.Ex.: Reference Examples
C.R.Ex.: Comparative Reference Example

### Reference Example 4 (Molding of Disk)

The procedure of Example 17 was repeated except that PC-3 was used and a polycarbonate powder containing 5,000 ppm of tris(2,4-di-t-butylphenyl)phosphite and 50,000 ppm of monoglyceride stearate was added to PC-3 in an amount of 1 wt % based on the polymer to mold a substrate and the characteristic properties of the obtained substrate were evaluated. As a result, an achromatic transparent substrate having 0.5 PO error and 0.4 white point was obtained.

1. A resin composition comprising:
(A) a polycarbonate having a viscosity average molecular weight of at least 10,000 obtained by filtration in a molten state with a filter comprising an assembly of a plurality of disk filter elements having an outer diameter of 15 inches or less, an inner diameter/outer diameter ratio of 1/7 or more and an opening size of 40 μm or less; and
(B) at least one member selected from the group consisting of an inorganic filler (B1) and a thermoplastic resin (B2) other than polycarbonates.

2. The resin composition of claim 1, wherein the polycarbonate (A) contains no more than 50 gels per kg.

3. The resin composition of claim 2, wherein the gel has an equivalent particle diameter of at least 20 μm.

4. The resin composition of claim 1 which comprises the component (B) in an amount of 1 to 300 parts by weight based on 100 parts by weight of the component (A).

5. The resin composition of claim 1, wherein the polycarbonate (A) contains at least one compound selected from the group consisting of a sulfonic acid compound, a phosphorus compound and an ester of an aliphatic alcohol and an aliphatic carboxylic acid.

6. The resin composition of claim 5, wherein the sulfonic acid compound is selected from the group consisting of tetrabutylphosphonium dodecylbenzenesulfonate and tetrabutylammonium paratoluenesulfonate, the phosphorus compound is selected from the group consisting of phosphoric acid, phosphorous acid and esters thereof, and the ester of an aliphatic alcohol and an aliphatic carboxylic acid is selected from the group consisting of a stearate of glycerin and a stearate of pentaerythritol.

7. The resin composition of claim 1, wherein the inorganic filler is selected from the group consisting of glass fiber, carbon fiber, mica, calcium carbonate, titanium oxide, silica, alumina and clay.

8. The resin composition of claim 1, wherein the thermoplastic resin other than polycarbonates is selected from the group consisting of polyethylene terephthalate, polybutylene terephthalate, acrylonitrile/styrene/butadiene copolymer and high impact strength polystyrene.

9. The resin composition of claim 1, wherein the polycarbonate (A) contains no more than 200 ppm of an aromatic monohydroxy compound and no more than 200 ppm of a diaryl carbonate.

10. The resin composition of claim 1, wherein the polycarbonate (A) is obtained by filtration in a molten state at a pressure difference of 20 kg/cm².

11. The resin composition of claim 1, wherein the polycarbonate (A) is obtained by filtration in a molten state at a throughput of 50 kg/m²/hr, said m² being the filtration unit area of the filter.

12. The resin composition of claim 1, wherein the polycarbonate (A) is obtained by filtration at a filter residence time (V/W) represented by the following equation:
V/W=0.2 to 10
wherein V is the inside effective volume (1) of the filter and W is the flow rate (l/min) of the filtered polymer.

13. The resin composition of claim 1, wherein the polycarbonate (A) is obtained by filtration at a lowest flow velocity of a polymer in the filter represented by the following formula:
W/A′×1,000=1 to 10,000 cm/min
wherein W is the flow rate (l/min) of the filtered polymer and A′ is the largest area (cm²) of a polymer flow path in the filter.

14. The resin composition of claim 1, wherein the distance between the opposite filtration surfaces of adjacent disk filter elements is 5 mm or less.

15. The resin composition of claim 1, wherein the polycarbonate (A) is obtained by polycondensing an aromatic diol compound and a carbonic acid diester compound in the presence or absence of a catalyst.

16. The resin composition of claim 1 which comprises a polycarbonate (A) and an inorganic filler (B1).

17. The resin composition of claim 1 which comprises a polycarbonate (A) and a thermoplastic resin (B2) other than polycarbonates.

18. The resin composition of claim 1 which comprises a polycarbonate (A), an inorganic filler (B1) and a thermoplastic resin (B2) other than polycarbonates.

19. The resin composition of claim 16, wherein the inorganic filler (B1) is contained in an amount of 1 to 150 parts by weight based on 100 parts by weight of the polycarbonate (A).

20. The resin composition of claim 17, wherein the thermoplastic resin (B2) other than polycarbonates is contained in an amount of 10 to 150 parts by weight based on 100 parts by weight of the polycarbonate (A).

21. The resin composition of claim 18, wherein the inorganic filler (B1) is contained in an amount of 1 to 150 parts by weight based on 100 parts by weight of the polycarbonate (A) and the thermoplastic resin (B2) other than polycarbonates is contained in an amount of 10 to 150 parts by weight.
